(19) United States
(12) Patent Application Publication
(10) Pub. No.: US 2022/0293952 A1
(43) Pub. Date: Sep. 15, 2022

(54) AN ELECTRODE MATERIAL AND COMPONENTS THEREFROM FOR USE IN AN ELECTROCHEMICAL DEVICE AND PROCESSES FOR THE MANUFACTURE THEREOF

(71) Applicant: BROADBIT BATTERIES OY, Espoo (FI)

(72) Inventor: David BROWN, Helsinki (FI)

(73) Assignee: BROADBIT BATTERIES OY, Espoo (FI)

(21) Appl. No.: 17/634,966

(22) PCT Filed: Aug. 12, 2020
(86) PCT No.: PCT/FI2020/050525

§ 371 Date: Feb. 12, 2022

(30) Foreign Application Priority Data
Aug. 13, 2019 (FI) 20195677

(51) Int. Cl. H01M 4/62; H01M 4/04; H01G 11/86; H01G 11/38

(52) U.S. Cl. CPC H01M 4/625; H01M 4/0435; H01G 11/86; H01G 11/38; H01M 4/622

(57) ABSTRACT

Described is a process mixture for use in and/or for the manufacture of one or more dry films, an article for use in an electrochemical device, a method for making a dry film or an article for an electrochemical device. The dry films can be incorporated in an article. The article can be incorporated in an electrochemical device. The process mixture ingredients may comprise one or more reactive materials and/or reactive composites. The reactive composite may comprise one or more reactive materials and one or more matrix materials. The reactive composite or the process mixture may comprise one or more binders. The process mixture may be a dry blend or a paste. One or more binders may be fibrillizable and/or is fibrillized. The dry blend may be made from a paste. The article may comprise a dry film derived from a process mixture. The dry film may be an element of an anode and/or a cathode. The method may comprise the steps of preparing a process mixture by mixing the ingredients present in process mixture in a mixer and then forming the process mixture into the film of an article of the invention in a film former. One or more of the reactive composites, may be produced by separately mixing one or more matrix materials and one or more reactive materials in a mixer to form a wet or dry reactive composite. The method may further comprise the step of applying the film to a final substrate. The film may be sheared during film forming and/or film application to fully or partially fibrillizes some or all of the one or more fibrillizable binders. An electrochemical device may comprise any of the process mixture, dry films or articles of the invention.

### FIELD OF INVENTION

The present invention relates to materials, components and manufacturing techniques thereof for use in electrochemical devices, such as electrochemical cells. In particular, the present invention relates to dry blends or pastes for use in and/or for the manufacture of an article used in an electrochemical device, an article, such as an anode or a cathode, used in an electrochemical device, comprising a dry film comprising said dry blend and/or derived from said dry blend, paste or pasty film, a method for manufacturing said article, an electrochemical device, comprising said dry blend and/or made from said dry blend, paste, dry film and/or pasty film, said article and/or an article made according to said method and an apparatus for the manufacturing of said materials and articles.

### BACKGROUND

Traditional electrodes for electrochemical devices, such as batteries and supercapacitors, are made by slurry coating processes in which the electrode ingredients, including any glue like binders or other additives, are mixed into a slurry, which is then formed at high temperatures by spreading the slurry on a thin sheet of substrate foil and dried in an oven. The process is expensive, energy intensive, time consuming, and due to the large amounts of process additives, such as toxic solvents, is damaging to health and the environment. A new blend of electrode materials eliminating or greatly reducing the need for process additives, and in particular, removing or greatly reducing the need for solvents, and a process to produce electrodes for electrochemical devices eliminating the cost and complexity or removing and handling such process additives would be beneficial to both commerce and industry.

SUMMARY OF INVENTION Described is a process mixture for use in and/or for the manufacture of one or more dry films. The dry films can be incorporated in an article. The article can be incorporated in an electrochemical device. The process mixture ingredients may comprise one or more reactive materials and/or reactive composites. The the reactive composite may comprise one or more reactive materials and one or more matrix materials. The reactive composite alone, and/or the process mixture, with or without the reactive composite, may comprise one or more binders. The ratio of ingredients, in the process mixture as a whole and/or in the reactive matrix, may be predetermined ratio. The process mixture may a dry blend or a paste. The process mixture may further comprise one or more conductive additives. The conductive additives may be in a predetermined ratio to the other ingredients of the process mixture. One or more of the binders may be an element of the process mixture as a whole. One or more of the binders may be an element of one or more of the reactive composites. One or more of the reactive materials may be an active material and/or a precursor material. The precursor material may be a precursor to an active material. One or more of the reactive composites may be an active composite and/or a precursor composite. One or more of the precursor materials may be a precursor to an active material. Some or all of the reactive materials and/or some or all of the reactive composites and/or some or all of the matrix materials and/or some or all of the binders and/or some or all of the conductive additives and/or any combination thereof in the process mixture and/or reactive composite may be in the form of particles and/or grains and/or are in solid phase. At least some of the one or more binders may be fibrillizable and/or is fibrillized. The process mixture may comprise substantially no non-fibrillizable binders. The paste may comprise less than 85% liquid and/or background fluid by mass. The dry blend and/or a dry blend derived from the paste may comprise substantially no liquids. The dry blend and/or a dry blend derived from the paste may comprise a dry powder. The reactive materials may be dry reactive materials. The reactive composites may be dry reactive composites. The matrix materials may be dry matrix materials. The binders may be dry binders. The conductive additives may be dry conductive additives. The dry blend may be made from a paste. The dry blend may comprise substantially no processing additives or other intentionally added material. The conductive additives of the process mixture may comprise carbon or an allotrope thereof and/or a metal. The conductive additive may be in the form of a conductive high aspect ratio particle. One or more of the reactive materials may comprise a salt comprising a metal containing cation and an anion. One or more of the matrix materials comprises carbon and/or an allotrope of carbon. The metal of the salt's metal containing cation may comprise an alkali metal and/or the salt's anion is a halide. The salt's alkali metal may comprise Li, Na and/or K. The salt's halide may comprise F, Cl, S and/or Br.

An article for use in an electrochemical device is described, the article may comprise a dry film. The dry film may comprise a dry blend according the invention and/or be derived from a process mixture according to the invention. The dry film may be a freestanding film and/or a supported film. The dry film may be continuous and/or adhesive. Some or all of the one or more conductive additives in the film may makes direct ohmic contact within the dry film. The one or more conductive additives may form one or more conductive pathways within the dry film. The dry film may be an element of an anode and/or a cathode. The dry film may be bonded to, adhered to or otherwise coupled with a substrate, such as a final substrate. The final substrate may be an adhesive substrate. The final substrate may be electrically conductive. The final substrate may have an adhesion enhancing surface and/or an adhesion enhancing morphology. The adhesion enhancing surface may be a rough and/or porous and/or textured surface. The electrically conductive final substrate may be a current collector. The current collector may be an anodic current collector or a cathodic current collector. The dry film may be bonded to, adhered to or otherwise coupled with the anodic current collector or the cathodic current collector. The dry film bonded to, adhered to or otherwise coupled with the anodic current collector may be an anode. The dry film bonded to, adhered to or otherwise coupled with the cathodic current collector may be a cathode. Some or all of the reactive material and/or reactive composite, matrix material and binder may be intermixed within the dry film with a first ratio, wherein some of the reactive material and/or reactive composite, matrix material and/or binder is intermixed within the dry film with at least one opposing different second ratio, wherein the dry film with first ratio of materials provides enhanced electrode functionality, and wherein the dry film with the second ratio of materials provides enhanced adhesive functionality. Some or all of the conductive additive may be intermixed within the dry film with a first ratio, wherein some of the conductive additive may be intermixed within the dry film with at least one opposing different second ratio, wherein the dry film with the second ratio may provide higher conductivity than the dry film with the first ratio. The ratio of reactive material and/or reactive composite and/or matrix material and/or binder and/or the conductive additive may be distributed within the dry film with a gradually changing gradient of one or more of the reactive materials and/or reactive composites and/or matrix materials and/or binders and/or conductive additive.

A method for making a dry film or an article for an electrochemical device, is described. The method may comprise the steps of preparing a process mixture according to the invention by mixing the predetermined ratio of ingredients present in process mixture in a mixer and then forming the process mixture into the film of an article of the invention in a film former, wherein the film is a dry film or pasty film. One or more of the reactive composites, may be produced by separately mixing one or more matrix materials and one or more reactive materials in a mixer to form a dry reactive composite. One or more of the reactive composites, may be produced by separately mixing one or more matrix materials, one or more reactive materials and one or more background fluids and/or dispersants in a mixer to form a wet reactive composite. Some or all of the mixing may be carried out by shaking, milling, grinding, shearing, sonicating, shaking, vibrating, mortaring, tumbling, fluidizing and/or stirring. Some or all of the mixing may be carried out by dispersing one or more of the matrix materials and one or more reactive materials and/or one or more binders and/or conductive additives in one or more dispersants to create a dispersion and then fully removing the dispersant to create a mixed powder or partially removing the dispersant to create a paste, wherein the remaining dispersant may act as a background fluid. Some or all of the mixing may be carried out by substantially in the absence of any dispersant to create a mixed powder. Some or all of the mixing may be carried out with the additional step of adding a background fluid to create a paste. The dispersant may be a solvent, a suspendant, and/or a colloidant. The dispersion may be a solution, a suspension and/or a colloid. Dispersing may comprise suspending, dissolving and/or colloiding. Some or all of the dispersant may be removed by evaporation, drum drying, filtration, chemical reaction, precipitation, crystallization, extraction, compression, acceleration, deceleration, centrifugation, impaction and/or solidification. The process mixture may be sheared during the mixing. The evaporation may be carried out by vibration, sonification, heating, vacuuming, spray drying, freeze drying, fluidized bed drying, supercritical drying and/or depressurization. The heating may be convective, conductive, vibrational, frictional and/or radiative heating. The method may further comprise the step of applying the film to a final substrate. The film may be applied to the final substrate by mechanical compression. The film may be sheared during film forming and/or film application. The final substrate may be an adhesive substrate. The mechanical compression and/or the shearing may be carried out by calendering between two or more calendering cylinders having the same or different surface speeds at the nip between the calendering cylinders. The mechanical compression and/or shearing can be carried out by pressing between two or more stationary, co-moving or non-co-moving planar or contoured plates. Some or all of the process mixture, the film and/or any of the components thereof may be heated and/or cooled before, during and/or after applying the film to the final substrate. The shearing during mixing, film formation and or film application may fully or partially fibrillizes some or all of the one or more fibrillizable binders.

An electrochemical device is described. The electrochemical device may comprise any of the reactive materials and/or active materials and/or precursor materials and/or matrix materials, and/or binders and/or current collectors, and or separators, and or anodes and/or cathodes and or electrolytes described in any of the various embodiments of the invention. The electrochemical device may comprise the process mixture of any embodiment of the invention. The electrochemical device may comprise the article of any embodiment of the invention. The electrochemical device may comprise the article made according to the method of any embodiment of the invention. The electrochemical device may be an electrochemical cell. The electrochemical cell may comprise an electrolyte and an anode and/or a cathode. The anode may comprise an article of the invention. The cathode may comprise an article of the invention. The electrochemical cell may further comprise a separator. The electrochemical cell may be a battery cell, a supercapacitor cell or an electrodeposition cell. The dry blend and/or the dry film of one or more of the one or more articles of the electrochemical cell may be bonded to, adhered to or otherwise coupled with the separator. The bonding to the separator may be dry bonding.

An apparatus for the manufacture of all or part of the described process mixture and the described article for use in an electrochemical device is described as well as an apparatus for carrying out the method. The apparatus may include means for mixing, shearing, film forming and/or film applying.

### BRIEF DESCRIPTION OF THE DRAWINGS

FIG. 1a: A dry blend according to one embodiment of the invention comprising a binder distributed around particles of reactive material, reactive composite comprising reactive material and matrix material and conductive additive.

FIG. 1b: A dry blend according to one embodiment of the invention comprising particles of binder, reactive material, reactive composite comprising reactive material and matrix material and conductive additive.

FIG. 1c: A paste according to one embodiment of the invention comprising particles of binder, reactive material, reactive composite comprising reactive material and matrix material and conductive additive in a background fluid.

FIG. 1d: A paste according to one embodiment of the invention comprising particles of binder, reactive material, reactive composite comprising reactive material and matrix material and conductive additive in a background fluid.

FIG. 2a: An article according to one embodiment of the invention comprising a dry blend comprising a binder distributed around particles of reactive material, reactive composite comprising reactive material and matrix material and conductive additive formed into a film adhered to a substrate having a adhesion enhancing surface and morphology.

FIG. 2b: A dry film according to one embodiment of the invention having two compositions.

FIG. 2c: A dry film according to one embodiment of the invention having a continuous variation in composition.

FIG. 2d: A film in an intermediate state according to one embodiment of the invention, wherein the film is a pasty film and the background fluid of the paste is removed to form a dry film.

FIG. 2e: A pasty film according to one embodiment of the invention having two compositions.

FIG. 2f: A pasty film according to one embodiment of the invention having a continuous variation in composition.

FIG. 3a: A mixing procedure for preparing a dry blend according to one embodiment of the invention, wherein the dry blend comprises one or more reactive materials and/or one or more reactive composites and one or more binders.

FIG. 3b: A mixing procedure for preparing a dry blend according to one embodiment of the invention, wherein the dry blend comprises one or more reactive materials and/or one or more reactive composites, one or more binders and one or more conductive additives.

FIG. 3c: A mixing procedure for preparing a dry blend or paste according to one embodiment of the invention, wherein the dry blend or paste comprises one or more reactive materials and/or one or more reactive composites, one or more binders and one or more conductive additives and all or part of the one or more dispersants and/or background fluids are fully or partially removed.

FIG. 4a: An embodiment of the invention for producing a freestanding film from a process mixture by means of a film former calender together with an embodiment for an article of the invention wherein the film is deposited on a substrate by means of a separate film applier calender.

FIG. 4b: An embodiment of the invention for producing a supported film from a process mixture by means of a film former calender together with an embodiment for an article of the invention wherein the film is deposited on a substrate by means of a combined film applier calender.

FIG. 4c: An embodiment of the invention for producing a supported film from a process mixture by means of a film former calender together with an embodiment for an article of the invention wherein the film is deposited in a substrate by means of a combined film applier calender.

FIG. 4d: An embodiment of the invention for producing multiple supported films from multiple process mixtures by means of a multiple film former calender together with an embodiment for an article of the invention wherein the film is deposited on a substrate by means of a combined film applier calender.

FIG. 4e: An embodiment of the invention for producing a supported film from a process mixture by means of a single combined film former calender and film applier calender.

FIG. 4f: An embodiment of the invention for producing a multiple supported films from multiple process mixtures by means of a single combined film former calender and film applier calender.

FIG. 4g: An embodiment of the invention for producing a supported film having multiple layers from a multiple process mixtures by means of multiple combined film former calender and film applier calenders.

FIG. 5a: An embodiment of an electrochemical device according to one embodiment of the invention having an electrode comprising a current collector and an electrode film and an electrolyte.

FIG. 5b: An embodiment of an electrochemical cell according to one embodiment of the invention having an anode comprising an anodic current collector and an anode film, an cathode comprising an cathodic current collector and a cathode film and an electrolyte.

FIG. 5c: An embodiment of an electrochemical cell according to one embodiment of the invention having an anode comprising an anodic current collector and an anode film, an cathode comprising an cathodic current collector and a cathode film, an electrolyte and a spacer.

FIG. 5d: A double sided electrode having a film deposited on both side of the same current collector.

FIG. 6a: An embodiment of mixing and film processing for freestanding film according to one embodiment of the invention.

FIG. 6b: An embodiment of mixing and film processing for freestanding film according to one embodiment of the invention.

FIG. 6c: An embodiment of mixing and film processing for supported film according to one embodiment of the invention.

### DETAILED DESCRIPTION OF THE EMBODIMENTS

Detailed embodiments of the present invention are disclosed herein with reference to the accompanying drawings.

Definitions:

“Dry” here may mean being substantially liquid-free, background fluid-free and/or dispersant-free, preferably less than 5% and more preferably less than 2% and more preferably less than 1% and more preferably less than 0.5% and more preferably less than 0.2% and more preferably less than 0.1% and more preferably less than 0.05% and more preferably less than 0.02% and most preferably less than 0.01% by weight of liquid and/or dispersant.

A “liquid” here may refer to any nearly incompressible substance, such as a fluid, that may conform to the shape of its container but may retain a nearly constant volume and/or density independent of pressure, i.e., it may have a definite volume but no fixed shape. Liquids here may include, for instance, ionic liquids, plasmas or gels.

A “dry blend” here may refer to a mixture of solids which is, substantially liquid and/or dispersant-free. A dry blend may be converted to, or derived from, a paste, a wet mixture or a wet dispersion. The conversion or derivation may be by, for instance, drying or reacting. The drying or reacting may be by, for instance, evaporating, chemically reacting, solidifying, centrifuging or otherwise removing or converting to gas or solid some or all of the liquids, background-fluids and/or dispersants present in the paste, wet mixture, wet dispersion or other precursor to the dry blend.

An “electrochemical device” here many mean, for instance, an electrochemical cell, for instance, a battery or supercapacitor, an electrodeposition device or any other device wherein an electrochemical reaction takes place.

An “Electrochemical cell” here may mean a device capable of either generating electrical energy from chemical reactions or facilitating chemical reactions through the introduction of electrical energy. An electrochemical cell may comprise and anode, a cathode and an electrolyte. The electrolyte may be between the anode and the cathode. An electrochemical cell may further comprise a separator between the anode and cathode. An electrochemical cell may further comprise a housing. The anode and/or the cathode may comprise a current collector. Examples of electrochemical cells include, but are not limited to, batteries and supercapacitors.

“Substantially liquid and/or dispersant-free” here means having substantially no or very low liquid and/or dispersant, preferably having less than 5% and more preferably less than 2% and more preferably less than 1% and more preferably less than 0.5% and more preferably less than 0.2% and more preferably less than 0.1% and more preferably less than 0.05% and more preferably less than 0.02% and most preferably less than 0.01% by weight of liquid, background fluid and/or dispersant.

A “Wet mixture” here may include any mixture of material that is not dry and/or is not liquid-, background fluid- and/or dispersant-free. Wet mixtures include wet dispersions and pastes.

A “Wet dispersion” here may include, but is not limited to solutions, suspensions and colloids. Other wet dispersions are possible according to the invention. Wetting may be by any appropriate liquid, including, for instance, traditional liquids, ionic liquids, or gels. Dispersing here may mean mixing a solid with a wet dispersant to create a wet dispersion. The process of creating a wet dispersion is here termed wet dispersing. Here a dispersant may be a liquid, including a traditional liquid, an ionic liquid, or a gel, which may include a solvent, a colloid's external phase, a suspension's continuous phase or the like. Here, a suspendant is a dispersant for a suspension, a colloid continuous phase (here termed a colloidant) is a dispersant for a colloid and a solvent is a dispersant for a solution.

A “solution” may describe a wet dispersion, preferably an essentially homogeneous mixture, which may be composed of two or more substances. In such a wet dispersion, a solute may be a substance dissolved in another substance, termed a solvent. The solution may, more or less, take on some or all of the characteristics of the solvent, including, for instance, its phase. The solvent may be the major fraction of the wet dispersion. The process of creating a solution is here termed dissolving. Colloids and suspensions may be different from solutions, in which the dissolved substance (solute) does not exist as a solid, and solvent and solute are essentially homogeneously mixed.

A “suspension” may describe a wet dispersion comprising solid particles and/or grains (an internal phase) and a fluid (an external phase). A suspension may comprise solid particles and/or grains that are sufficiently large for sedimentation. The solid particles and/or grains preferably may be larger than 0.1 micrometer and more preferably may be larger than 1 micrometer. The solid particles and/or grains may be larger than 10 micrometers. The solid particles and/or grains may be larger than 100 micrometers. The internal phase (solid) may be dispersed throughout the external phase (fluid) my any means. The fluid may be any appropriate fluid, including a liquid. Liquids here may include, in addition to traditional liquids, ionic liquids and gels. Preferably the internal and external phases are dispersed through mixing. The dispersion may be aided by the use of certain excipients and/or suspending agents. If left undisturbed for a sufficient period, solid particles and/or grains may eventually settle out of the suspension over time. The process of creating a suspension is here termed suspending.

A “colloid” may describe a wet dispersion in which one substance of insoluble particles and/or grains is dispersed throughout another substance. Unlike a solution, whose solute and solvent constitute only one phase, a colloid may have a dispersed phase (the suspended particles and/or grains) and a continuous phase (the medium of suspension). In a colloid, the mixture may be one that does not settle over time or would take a very long time to settle appreciably. The process of creating a colloid is here termed colloiding.

Here “mixing” may be by mechanical or any other means, including but not limited to agitation, shaking, milling (e.g. ball milling), grinding, shearing, sonicating, shaking, vibrating, mortaring, tumbling, fluidizing and/or stirring. Other means of mixing are possible according to the invention.

Here a “Process mixture” here may mean a dry blend and/or a paste according to the invention, which may be formed into a film according to the invention, which may be a dry film and/or a pasty film. The process mixture may comprise, at least, a reactive material, a matrix material and a binder. The process mixture may further comprise a conductive additive and/or a background fluid.

Here a “precursor mixture” here may mean a mixture of ingredients of a process mixture, plus any processing additives that may be fully or partially removed in the preparation of the process mixture, before said process mixture is formed into a film (11) according to the invention.

A process mixture may be prepared in a single stage or in multiple stages. If prepared in a single stage, all the ingredients of the process mixture may be added to the mixer at the same time and the ingredients may be mixed for the same time period. If prepared in two stages, a first part of the ingredients of the process mixture may be added to the mixer at a first time and the first part of the ingredients of the process mixture may be mixed for a first time period in stage 1 and, after the first time period has elapsed, a second part of the ingredients of the process mixture may be added to the mixer at a second time and the first and second parts of the ingredients of the process mixture may be mixed for a second time period in stage 2. If prepared in three stages, a first part of the ingredients of the process mixture may be added to the mixer at a first time and the first part of the ingredients of the process mixture may be mixed for a first time period in stage 1 and, after the first time period has elapsed, a second part of the ingredients of the process mixture may be added to the mixer at a second time and the first and second parts of the ingredients of the process mixture may be mixed for a second time period in stage 2 and, after the second time period has elapsed, a third part of the ingredients of the process mixture may be added to the mixer at a third time and the first, second and third parts of the ingredients of the process mixture may be mixed for a third time period in stage 3. Similarly, the process can have four or more preparation stages. In certain cases, a part of the process mixture may be removed within or between stages. For example, a background fluid and/or processing additive may be added and/or removed within or between stages. This may be, for instance to maintain certain properties of the process mixture within or between stages or to change certain properties within or between stages. Such properties may be, for instance, the viscosity, the adhesivity and/or the background fluid and/or processing additive concentration within the process mixture. Some or all of the background fluid and/or processing additive may be fully or partially removed by any means, including, but not limited to evaporation, vibration, sonication or compression.

The parts of the mixture added at any of the stages may be any combination of individual ingredients or parts of individual ingredients. For instance, the ingredients added in the first stage may be all or part of each of the one or more materials A and one or more materials B, all or part of each of the one or more materials A, one or more materials B or one or more materials C, all or part of each of the one or more materials A, one or more materials B, one or more materials C, one or more materials D and/or one or more materials E, where materials A, B, C, D, and E may be reactive, matrix, binder, conductive additive, and/or processing additive materials in any combination or order. All or some of said materials A, B, C, D, and/or E may be present in the initial stage of mixing. All or some of said materials A, B, C, D, and/or E may be present in the later stages of mixing. The conditions (e.g. mixing type, mixing rate, mixing temperature etc.) of the various mixing stages may be the same or different. The process mixture may be sifted to remove or collect particles of a specific size or size range between any of the stages. Mixing may also involve shearing. Mixing may be done also by spraying andor by shearing and/or calendering, e.g., in a nip between two or more rollers or compressing and/or shearing between two plates.

In one preferred embodiment of the invention, the number of mixing stages may be two, material A may be one or more active materials, material B may be one or more matrix materials and material C may be a one or more binder materials. Material A, material B, and material C may be mixed in stage 1 at specific process conditions, for a specific time in a specific mixing machine, the resulting process mixture may be mixed in stage 2 at specific process conditions, for a specific time in a specific mixing machine, and the process mixture may be further mixed in stage 3 at specific process conditions, for a specific time in a specific mixing machine.

In one preferred embodiment of the invention, the number of mixing stages may be three, material A may be one or more active materials, material B may be one or more matrix materials, material C may be one or more binder materials, material D may be one or more conductive additive materials, and material E may be one or more processing additive materials, material A and material B may be mixed in stage 1 at specific process conditions, for a specific time in a specific mixing machine, the resulting process mixture may sifted to remove particles larger than a certain size, the resulting process mixture may be mixed in stage 2 together with material C at specific process conditions, for a specific time in a specific mixing machine, and the process mixture may be further mixed in stage 3 at specific process conditions, for a specific time in a specific mixing machine.

In one preferred embodiment of the invention, the number of mixing stages may be three, material A may be one or more active materials, material B may be one or more matrix materials, material C may be one or more binder materials, material D may be one or more processing additive materials, material A and material B may be mixed in stage 1 at specific process conditions, for a specific time in a specific mixing machine, the resulting process mixture may be mixed in stage 2 together with material C and material D at specific process conditions, for a specific time in a specific mixing machine, and the process mixture may be further mixed in stage 3 at specific process conditions, for a specific time in a specific mixing machine.

In one preferred embodiment of the invention, the number of mixing stages may be N, where N is greater than 2, material A may be one or more active materials, material B may be one or more matrix materials, material C may be one or more binder materials, material D may be one or more processing additive material, material A and material B may be mixed in stage 1 at specific process conditions, for a specific time in a specific mixing machine, the resulting process mixture may be mixed in stage 2 together with material C and material D at specific process conditions, for a specific time in a specific mixing machine, and the process mixture may be further mixed in stage 3, together with material D, at specific process conditions, for a specific time in a specific mixing machine. Stage 4 and beyond may repeat the process of stage 3. Stage 3 mixing may be accomplished by wetting, e.g. spraying, dipping or dripping, and may comprise an additional step of feeding the subsequent mixture through a nip between the rollers of a calendar.

A “paste” may be a substance that behaves as a solid until a sufficiently large load or stress is applied, at which point it flows like a fluid. A paste may be an example of a Bingham plastic fluid. Pastes may consist of a mixture of granular material in a liquid (the background fluid). Unlike a dispersion or slurry, in a paste the individual particles and/or grains may be jammed together like sand on a beach and/or may form a disordered, glassy or amorphous structure, which may give a paste a solid-like character. The background fluid of the paste preferably is less than 85% and more preferably less than 70% and more preferably is less than 65% and most preferably is less than 60% by mass of the paste. Here, in contrast to a paste, a slurry may describe a thin sloppy mud or cement or, in general, any fluid mixture of a pulverized solid with a liquid, which, unlike a paste, may behave like a thick fluid and/or, which may flow under gravity.

In some embodiments of the invention, the paste may comprise less than 50% background fluid. In some embodiments of the invention, the paste may comprise less than 40% background fluid. In some embodiments of the invention, the paste may comprise less than 30% background fluid. In some embodiments of the invention, the paste may comprise less than 20% background fluid. In some embodiments of the invention, the paste may comprise less than 10% background fluid. In some embodiments of the invention, the paste may comprise less than 5% background fluid. In some embodiments of the invention, the paste may comprise less than 2% background fluid. In some embodiments of the invention, the paste may comprise less than 1% background fluid. In some embodiments of the invention, the paste may comprise less than 0.5% background fluid. In some embodiments of the invention, the paste may comprise less than 0.2% background fluid. In some embodiments of the invention, the paste may comprise less than 0.1% background fluid. In some embodiments of the invention, the paste may comprise greater than 50% background fluid. In some embodiments of the invention, the paste may comprise greater than 40% background fluid. In some embodiments of the invention, the paste may comprise greater than 30% background fluid. In some embodiments of the invention, the paste may comprise greater than 20% background fluid. In some embodiments of the invention, the paste may comprise greater than 10% background fluid. In some embodiments of the invention, the paste may comprise greater than 5% background fluid. In some embodiments of the invention, the paste may comprise greater than 2% background fluid. In some embodiments of the invention, the paste may comprise greater than 1% background fluid. In some embodiments of the invention, the paste may comprise greater than 0.5% background fluid. In some embodiments of the invention, the paste may comprise greater than 0.2% background fluid. In some embodiments of the invention, the paste may comprise greater than 0.1% background fluid.

In some embodiments of the invention, the paste may comprise and combination of any of the upper and lower limits herein specified. In some embodiments of the invention, the paste may comprise between 85% and 0.1% background fluid. In some embodiments of the invention, the paste may comprise between 70% and 0.1% background fluid. In some embodiments of the invention, the paste may comprise between 65% and 0.1% background fluid. In some embodiments of the invention, the paste may comprise between 60% and 0.1% background fluid. In some embodiments of the invention, the paste may comprise between 55% and 0.1% background fluid. In one embodiment, the paste may comprise between 50% and 0.1% background fluid. In some embodiments of the invention, the paste may comprise between 85% and 0.2% background fluid. In some embodiments of the invention, the paste may comprise between 70% and 0.2% background fluid. In some embodiments of the invention, the paste may comprise between 65% and 0.2% background fluid. In some embodiments of the invention, the paste may comprise between 60% and 0.2% background fluid. In some embodiments of the invention, the paste may comprise between 55% and 0.2% background fluid. In one embodiment, the paste may comprise between 50% and 0.2% background fluid. In some embodiments of the invention, the paste may comprise between 85% and 0.5% background fluid. In some embodiments of the invention, the paste may comprise between 70% and 0.5% background fluid. In some embodiments of the invention, the paste may comprise between 65% and 0.5% background fluid. In some embodiments of the invention, the paste may comprise between 60% and 0.5% background fluid. In some embodiments of the invention, the paste may comprise between 55% and 0.5% background fluid. In one embodiment, the paste may comprise between 50% and 0.5% background fluid. In one embodiment, the paste may comprise between 50% and 0.2% background fluid. In some embodiments of the invention, the paste may comprise between 85% and 1% background fluid. In some embodiments of the invention, the paste may comprise between 70% and 1% background fluid. In some embodiments of the invention, the paste may comprise between 65% and 1% background fluid. In some embodiments of the invention, the paste may comprise between 60% and 1% background fluid. In some embodiments of the invention, the paste may comprise between 55% and 1% background fluid. In one embodiment, the paste may comprise between 50% and 1% background fluid. In some embodiments of the invention, the paste may comprise between 85% and 2% background fluid. In some embodiments of the invention, the paste may comprise between 70% and 2% background fluid. In some embodiments of the invention, the paste may comprise between 65% and 2% background fluid. In some embodiments of the invention, the paste may comprise between 60% and 2% background fluid. In some embodiments of the invention, the paste may comprise between 55% and 2% background fluid. In one embodiment, the paste may comprise between 50% and 2% background fluid. In some embodiments of the invention, the paste may comprise between 85% and 5% background fluid. In some embodiments of the invention, the paste may comprise between 70% and 5% background fluid. In some embodiments of the invention, the paste may comprise between 65% and 5% background fluid. In some embodiments of the invention, the paste may comprise between 60% and 5% background fluid. In some embodiments of the invention, the paste may comprise between 55% and 5% background fluid. In one embodiment, the paste may comprise between 50% and 5% background fluid.

A paste may be produced by applying one or more background fluids, liquids and/or dispersants to a powder or dry blend. In some embodiments of the invention, application of background fluid, liquid and/or dispersant may be via, for instance, a mixer. In some embodiments of the invention, application of background fluid, liquid and/or dispersant may be by placing the powder or dry blend under a wetter, such as a sprayer. In some embodiments of the invention, application of background fluid, liquid and/or dispersant may be via, for instance, a mixer and/or by placing the powder or dry blend under a wetter, such as a sprayer.

“Reactive material” here may be any material that chemically reacts, including but not limited to electrochemically, with another material. Active materials and/or active material precursors may be reactive materials according to the invention. A reactive material may be in the form of particles and/or grains. The reactive material may be a dry reactive material. In a dry blend, paste or film, the reactive material preferably comprises more than 40% and more preferably more than 60% and most preferably more than 70% of the solid mass of the dry blend, paste or film.

A “binder” here may mean any material or combination of materials that holds or draws other materials together to form a cohesive whole mechanically, chemically, or as an adhesive. A binder may bind materials, e.g. particles, inside films, e.g. electrodes and/or between materials in a film to a substrate, e.g. a current collector of an electrode. A binder may be fibrillizable. A binder may be fribrilized. Examples of binders include, but are not limited to, e.g. thermoplastics, including but not limited to polyethylene (PE), polypropylene (PP), such as nylon, PLA (Polylactic acid or polylactide), polybenzimidazole (PBI, short for Poly-[2,2′-(m-phenylen)-5,5′-bisbenzimidazole]), polycarbonate, polyether sulfone, polyetherether ketone, polyetherimide, polyethylene oxide (PEO), polyphenylene oxide, polyphenylene sulfide, polypropylene, polystyrene, polyvinyl chloride, acrylic polymers and their derivatives and fluoropolymers and any combination thereof. Examples of acrylic polymers and their derivative include, but are not limited to, Acrylic (poly(methyl methacrylate) or PMMA), ABS (acrylonitrile butadiene styrene), methacrylates, methyl acrylates, ethyl acrylates, 2-Chloroethyl vinyl ether, 2-Ethylhexyl acrylates, Hydroxyethyl methacrylates, butyl acrylates and butyl methacrylates and any combination thereof. Examples of fluoropolymers include, but are not limited to, polytetrafluoroethylenes (PTFEs), such as Teflon, polyvinylidene fluoride (PVDF), polyvinylidene fluoride-co-hexafluoropropylene (PVDF-HFP) and polyvinylidene fluoride co-polymers, polyvinylfluoride (PVF), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), Perfluorinated Elastomer (FFPM/FFKM), Chlorotrifluoroethylenevinylidene fluoride FPM/FKM, Tetrafluoroethylene-Propylene (FEPM), Perfluoropolyether (PFPE) and Perfluorosulfonic acid (PFSA) and any combination thereof. A binder may be in the form of particles and/or grains. The binder may be a dry binder. In a dry blend, paste or film, the binder preferably comprises less than 15% and more preferably less than 10% and more preferably less than 7% and more preferably less than 5% and more preferably less than 2% and most preferably less than 1% of the solid mass of the dry blend, paste or film. A binder may be mechanically processed into its final morphology in the dry film, pasty film or paste. A binder may be always in a solid state and/or never be dissolved, for instance, in a solvent, during processing or while in the dry film or paste.

“Active material” here may mean a reactive material that participates in a reaction, for instance an electrochemical reaction, in an electrochemical cell. Examples of active materials include, but are not limited to NaCl, NaF, Na₂SO₃, Na₂SiO₃, Na₄P₂O₇, NaAlCl₄, NaAlCl₄*xSO₂, NaAlCl₄*1.5SO₂, NaAlCl₄*3SO₂, SO₂Cl₂, SO₂, Cl₂, Ni, Cu, CuO, NiO, Cu₂O, Fe, FeO, Fe₂O₃, Fe₃O₄, steel, NiF₂, NiCl₂, FeCl₂, FeCl₃, FeF₂, FeF₃, CuCl₂, CuCl, CuF₂, CuF, porous carbon, Lithium mixed oxides and Lithium mixed phosphates, such as lithium iron phosphate (LFP), Lithium Manganese Iron Phosphate (LMFP), Lithium Nickel Cobalt Manganese oxide (NCM), Lithium Nickel Cobalt Aluminium oxides (NCA), Lithium Manganese oxide (LMO), Lithium Cobalt oxide (LCO) and combinations thereof. “x: in NaAlCl₄*xSO₂ may be any number between 1 and 5. An active material may be in the form of particles and/or grains. The active material may be a dry active material. An active material may be always in a solid state and/or never be dissolved in a solvent during processing or in the dry film.

“Active material precursor” (also termed “precursor material”) here may mean a material, which may be a reactive material, that may act as a precursor to an active material. Examples of precursor materials include, but are not limited to Na₂SO₃, Na₂SiO₃, Na₄P₂O₇, Ni, Cu, Fe, porous carbon, Cu(OH)₂, Fe(OH)₂, Cu₂CO₃(OH)₂, Cu(HCOO)₂ and combinations thereof. A precursor material may be in the form of particles and/or grains. The active material may be a dry precursor material. A precursor material may be always in a solid state and/or never be dissolved in a solvent during processing or in the dry film.

“Matrix material” here may mean a material that may serve as a mechanical support and/or available surface and/or a conduit (e.g. an electrical conduit), for enabling or promoting formation and/or dissolution of reactive materials (e.g. active materials and/or precursor materials). A matrix material is preferably not consumed during the electrochemical reaction of the electrochemical device. A matrix material may be electrically conductive or non-conductive and/or catalytic or non-catalytic. Examples of matrix materials include, but are not limited to, carbon and/or allotropes of carbon. Examples include, but are not limited to ketjen black, graphite, hard carbon, nanotubes, nanofibers, carbon nanotubes, carbon nanofibers, carbon nanobuds, activated carbon, reduced graphene oxide, celite, humic acid, diatomaceous earth, Ni, Cu, Fe, steel, brass, clays, bentonite, caolinite, Ni foam, Cu foam, Al foam, steel wool, Ni-plated metal, Fe-plated metal, microfibers, glass fiber, quartz fibers, basalt fibers, polyamide fibers, polyethylene fibers, polypropylene fibers and any combination thereof. A matrix material may be in the form of particles and/or grains. The matrix material may be a dry matrix material. In a dry blend, paste or film, the matrix preferably comprises less than 60% and more preferably less than 40% and most preferably less than 30% of the solid mass of the dry blend, paste or film. A matrix material may be always in a solid state and/or never be dissolved in a solvent during processing or in the dry film, pasty film or paste.

A “Reactive material—matrix material composite” (also termed “reactive composite”) here may mean a dry mixture or paste comprising, at least, reactive material and matrix material. When the reactive material is an active material, the reactive composite may be an “active material—matrix material composite” (also termed “active composite”). When the reactive material is an active material precursor (precursor material), the reactive composite may be an “precursor material matrix material composite (also termed “precursor composite”). Any of the reactive composites may further comprise additional materials such as conductive additives and/or binders. A reactive composite may be in the form of particles and/or grains. The reactive composite may be a dry reactive composite. A reactive composite may be always in a solid state and/or never be dissolved in a solvent during processing or in the dry film, pasty film or paste.

“Composite” here may mean a dry mixture or paste of a matrix material and at least one other material. A composite may comprise, for instance, a matrix material and a binder and/or a reactive material and/or a conductive additive. The mixture may mean a dry blend or a wet mixture.

A “Conductive additive” may mean a conductive material that enhances conductivity of a composite, dry mixture and/or dry blend. Enhanced conductivity here means having an electrical conductivity higher than before the enhancement. Examples of conductive additives include, but are not limited to conductive materials, e.g. metals, such as Ni, Cu, Fe, Al, brass, steel, CuNi alloys, Ag or metal like materials, such as carbon nanomaterials, e.g. graphene, graphite, nanotubes, fullerenes, carbon nanobuds, glassy carbon and/or carbon nanofoam, carbon nanowires and/or reduced graphene oxide and any combination thereof. A conductive additive may be in the form of particles and/or grains. Said particles and/or grains may be in the form of, e.g., spheres, rods, tubes and/or flakes. The conductive additive may be a dry conductive additive. A conductive additive may be always in a solid state and/or never be dissolved in a solvent during processing or in the dry film, pasty film or paste.

“Fibrillizable” here means capable of being fibrillized (also called fibrillated). “Fibrillized” (“fibrillated”) means to be converted into, or furnished with fibrils. A “fibril” here may be a fine fiber or filament. A binder may be fribrillizable and/or fibrillized. Fibrililization may be wet or dry fribrillization. Examples of fibrilizable materials include, but are not limited to high aspect ratio particles, thermoplastics, including but not limited to Acrylic (poly(methyl methacrylate) or PMMA), ABS (acrylonitrile butadiene styrene), nylon, PLA (Polylactic acid or polylactide), polybenzimidazole (PBI, short for Poly-[2,2′-(m-phenylen)-5,5′-bisbenzimidazole]), polycarbonate, polyether sulfone, polyetherether ketone, polyetherimide, polyethylene, polyphenylene oxide, polyphenylene sulfide, polypropylene, polystyrene, polyvinyl chloride and fluoropolymers. Examples of fluoropolymers include, but are not limited to, polytetrafluoroethylenes (PTFEs), such as Teflon.

“Processing additive” here means any additive that aids in processing of a material but substantially does not serve a function in the final product. A processing additive may include a material which is added during the electrode manufacturing process and subsequently removed at any stage before assembly of the electrochemical device. Examples of processing additives may include but are not limited to lubricants, surfactants, plasticizers, dispersants (e.g. solvents, suspendants or colloidants) and/or background fluids in pastes. Other processing additives are possible according to the invention. In general, any intentionally added material that does not serve a function in the final product may be termed a processing additive.

“Processing” here may mean, for instance, any process or process step carried or with the aim of transforming one or more of the raw materials into a process mixture, such as a dry blend or a paste, a mixture, a film, such as a dry film or a pasty film, an article, an electrode, such as an anode (12a) or a cathode, an electrochemical device such as an electrochemical cell, such as a battery or supercapacitor or any element thereof. Examples of processing steps include, but are not limited to, extruding, bonding, removing, fibrillizing, mixing, applying, adhering, calendaring and/or any other processing step present according to the various embodiments of the invention.

“Removal” (i.e. separation of liquids from solids) in the case of background fluids and/or dispersants, such as solutes, suspendants or colloidants, may be by any means known in the art. Removal may be by, for instance, mechanical separations (e.g. filtration and centrifugation). Removal may be by, for instance, diffusional separation (e.g. distillation, absorption, extraction). Removal may be by, for instance, membrane separation. Examples of removal mechanisms include, but are not limited to, evaporation, drum drying, filtration, chemical reaction, precipitation, crystallization, extraction, compression, acceleration, deceleration, centrifugation, impaction and/or solidification. Evaporation may be carried out by any means known in the art, including, but not limited to vibration, sonification, heating, vacuuming, spray drying, freeze drying, fluidized bed drying, supercritical drying and/or depressurization.

“Freestanding” here may mean able to fully or partially support itself and/or be essentially free of support or attachment for at least a portion of its length.

“Powder” here may mean a dry, bulk solid granular material composed of a large number of particles and/or grains that may flow freely when shaken or tilted.

“Film” here may mean a structure, e.g. a sheet, having one dimension (e.g. thickness) significantly smaller than the other dimensions (e.g. length and/or width). A “dry film” may mean a film that is dry and/or comprises a dry blend. A “pasty film” may be a film that is composed of a paste. Dry films and/or pasty films may be freestanding and/or supported, for instance, on a substrate, for instance a temporary substrate and/or a final substrate.

An “Adhesive substrate” here may mean any substrate having an adhesion enhancing surface or morphology. Examples include, but are not limited to, a solid or perforated sheets, foams, networks, sintered powders or agglomerates or meshes of material. A final substrate may be an adhesive substrate.

“Adhesion enhancing surface or morphology” here may mean a material surface and/or morphology that physically, mechanically and/or chemically enhances the adhesion of said surface or morphology to another material, e.g. a reactive material, an active material a precursor material, a matrix material, conductive additive, a binder, a reactive composite, an active composite, a precursor composite and/or a powder, a paste and/or a film. Said film may comprise a matrix material, a binder, a conductive additive, reactive material, an active material a precursor material, a matrix material, a reactive composite, an active composite and/or a precursor composite, and/or a powder, which may comprise a matrix material, a binder, a conductive additive, reactive material, an active material a precursor material, a matrix material, a reactive composite, an active composite and/or a precursor composite. Examples of adhesion enhancing surfaces or morphologies include, but are not limited to, meshes or porous materials, rough and/or textured surfaces and/or coated surfaces. Such surfaces, voids, channels, gaps dips and/or protrusions in such surfaces may, for instance, provide improved adhesion to, for instance, an applied dry blend, paste, film, matrix material, binder, conductive additive, reactive material, active material, active material precursor, reactive composite, active composite and/or precursor composite and/or increased surface area for interaction, e.g., adhesion, reaction and/or charge transfer to said dry blend, paste, film, matrix material, binder, conductive additive, reactive material, active material, active material precursor, reactive composite, active composite and/or precursor composite.

“Mesh or porous material” here may mean a sheet having patterned or unpatterned voids, channels, passages or holes. A mesh or porous material may be produced, for instance, by making patterned or unpatterned holes or cuts into a solid planar metallic sheet by e.g., molding, stamping or other mechanical means, by weaving or otherwise intermingling strands of material, by compressing, e.g. particles and/or grains of material, by chemical addition or removal, e.g. by etching, or by any other means. The mesh or porous material may have a 3-dimensional morphology. A mesh or porous material may be produced, for example, by making patterned cuts into a sheet, and then stretching it so as to transform the cuts into holes.

“Textured surface” here may mean a surface having a multitude of voids channels, gaps dips and/or protrusions. Said voids, channels, gaps dips and/or protrusions may be patterned, repeating or random. A textured surface may be produced, for instance, by making patterned or unpatterned indentations, punctures or scrapes into a solid planar metallic sheet by e.g., molding, stamping or other mechanical means, by chemical addition or removal, e.g. by etching, or by any other means. The textured surface may be a rough surface.

“Rough” here may mean having a coarse or uneven surface, as from, e.g., projections, irregularities, or breaks. Preferably, the roughness, as measured in terms of roughness value (Ra), is 0.25 microns or above.

“Adhered to or otherwise coupled with” here may refer to bonded and/or mechanically interlocked, wedged and/or otherwise intermingled. Bonding can be, for instance by dry bonding, chemical adhesion, dispersive adhesion and/or diffusive adhesion. Mechanically interlocking can be, for instance, by filling voids, channels or pores of the surfaces or bulk material and/or surrounding fibers or threads at the surface or in the bulk material. Adhesion or coupling can be achieved by applying a material as a powder, dry blend, paste or film on both sides of a mesh or porous material such that, upon application, the material applied to one side of the mesh and/or porous material touches and/or bonds to the material applied to the other side of the mesh or porous material. A film and/or a process mixture may be adhered to or otherwise bonded to a substrate.

“Self adhesion” may mean when two components of the same or similar material (for instance two same or differing compositions of process mixtures or two same or different compositions for films) adhere to one another. In the case of, for instance, a mesh or porous substrate or any substrate that has sufficiently large pores, gaps, holes, voids or channels to allow one or more continuous pathways from one side of the substrate to the other, two films can be adhered to or otherwise coupled with the substrate by self adhesion through one or more of the pores, gaps, holes, voids or channels. Thus, the films may, at least partially, be adhered to or otherwise coupled with the substrate by self adhesion.

“Dry bonding” here may describe bonding my means of heat and/or pressure. Dry bonding may be in the absence of liquids and/or chemical reaction during bonding.

“Electrode functionality” here may mean enabling, promoting or otherwise facilitating oxidation and/or reduction reactions, charge transfer, or other electrochemical functions of the electrode, e.g. the anode and/or cathode, within an electrochemical cell.

A “High Aspect Ratio Particle” here may mean here particles having one dimension significantly larger than the other dimensions of the particle. The high aspect ratio particles may be conductive or non-conductive. Examples of High Aspect Ratio Particle include but are not limited to conductive flakes, chips, fibers, tubes, ribbons, rods and/or strings. The smallest dimension of the structure may be of nanometer scale or above. The largest dimension may be of micron scale or below. The ratio of the largest dimension to the smallest dimension may be greater than 2 and more preferably greater than 4 and more preferably greater than 10 and more preferably greater than 20 and more preferably greater than 50 and most preferably greater than 100. Examples of high aspect ratio particles include, but are not limited to, carbon nanotubes (CNTs), fullerene functionalized carbon nanotubes, such as NanoBuds (CNBs), graphene, graphite, carbon nanoribbons and metal flakes, chips, fibers, tubes, rods and/or strings. Other materials and morphologies that have a high aspect ratio and are conductive are possible according to the invention. A conductive pathway of high aspect ratio particles may mean two or more conductive high aspect ratio particles in contact, creating an essentially continuous conductive network extending over a distance longer than the longest dimension of an individual high aspect ratio particle.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

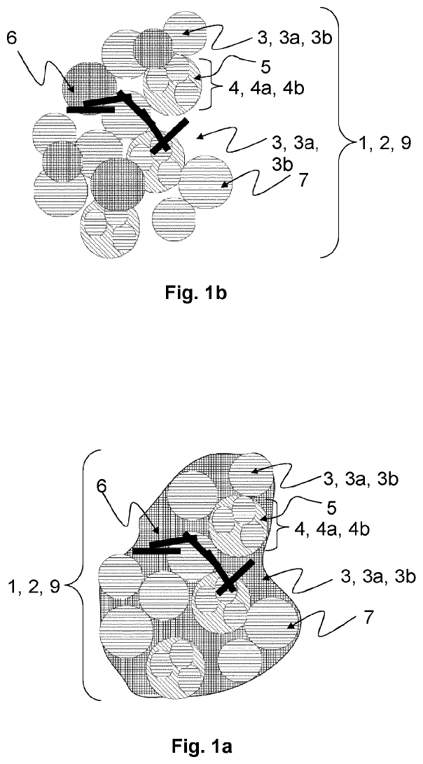

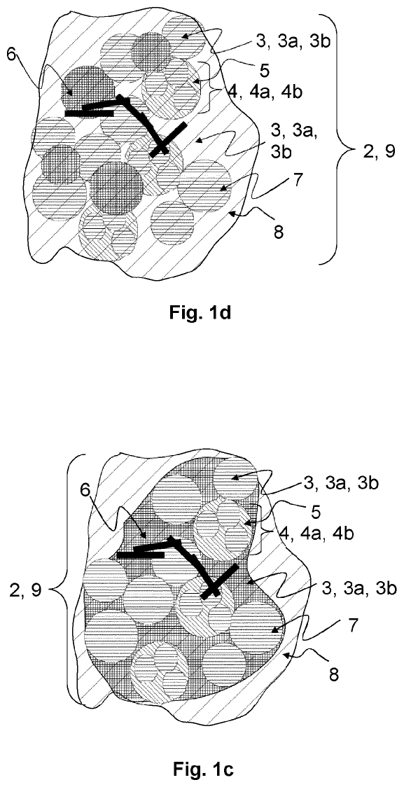

FIG. 1A shows an embodiment of the invention wherein a process mixture (9), such as a dry blend (1) or paste (2), for use in and/or for the manufacture of an article (10) used in an electrochemical device, comprises one or more reactive materials (3) and/or reactive composites (4). The reactive composite, when present, may comprise one or more reactive materials (3) and one or more matrix materials (5). The dry blend (1) or paste (2) may further comprise one or more binders (6). One or more of the reactive materials may comprise one or more active materials (3a) and/or one or more precursor materials (3b). The precursor material (3b) may be a precursor to an active material (3a). The process mixture (9) may further comprise one or more conductive additive (7). The conductive additives may form a conductive pathway through all or part of the material. In the embodiment of FIG. 1A, the binder (6) may be distributed around the other materials (reactive materials (3, 3a, 3b), reactive composites (4, 4a, 4b), conductive additives (7)). According to one aspect of the invention, this may occur, for instance, before, during or after processing when the binder (6) may become fully or partially fibrillized. In such a circumstance, some or all of said other (non-binder) materials may be in the form of particles and/or grains and/or are in solid phase. The process mixture (9) may comprise substantially no non-fibrillizable binders.

The use of multiple binders (6) in a given process mixture (9) is advantageous in some cases. In particular, binders (6) with differing melting points have been surprisingly found to have a synergistic effect. As an exemplary embodiment, a binder (6) may comprise both teflon (PTFE) and polyethylene-oxide (PEO). This combination has been found to be particularly effective for Li-ion cathodes (12b). When pure PTFE binder is used with a Li-ion cathodic active material at 120° C. compounding temperature, along with 6% conductive carbon additives, the obtained electrode material has 1.4 g/cm³ density. When PEO:PTFE binders are used in 1:1 ratio on the same cathodic active material at same 120° C. compounding temperature and same amount of carbon additives, the obtained electrode material has 1.7 g/cm3 density. This densification is attributed to the reduced viscosity of the compounded electrode material. The resulting electrode material can be further densified by calendering. Moreover, at 120-160° C. processing temperature range, the PEO:PTFE binder has been found to create stronger adhesion to the current collector than pure PTFE binder. This stronger adhesion is attributed to the lower melting point of PEO. While the use of PEO creates these advantages, it is not a suitable binder on its own. Without intending to be bound by theory, the need for the presence of PTFE is attributed to its better fibrillizing properties, and furthermore its cathodic chemical stability is advantageous for the electrode longevity. The synergistic advantages of blended binder materials are surprising. Other combinations, including binders and binder ratios, of multiple binders are allowed by the invention.

The dry blend (1) may comprise substantially no liquids. The dry blend (1) may be a dry power. All or part of the individual constituents of the dry blend may be dry before, during, and/or after processing. The reactive materials (3) may be dry reactive materials before, during, and/or after processing. The reactive composites may be dry reactive composites before, during, and/or after processing. The binders may be dry binders before, during, and/or after processing. The conductive additives may be dry conductive additives before, during, and/or after processing. The matrix material (5) may be a dry matrix material before, during, and/or after processing. The dry blend may be made from a paste.

FIG. 1B shows an embodiment of the invention wherein, in the process mixture (9), such as a dry blend (1) or paste (2), some or all of the reactive materials (3, 3a, 3b) and/or some or all of the reactive composites (4, 4a, 4b) and/or some or all of the matrix materials (5) and/or some or all of the binders (6) and/or some or all of the conductive additives (7) and/or any combination thereof are in the form of particles and/or grains and/or are in solid phase. According to one aspect of the invention, this may occur, for instance, before, during or after processing when the binder (6) has not or has not yet become fully or partially fibrillized.

The dry blend (1), as shown in FIGS. 1A and 1B may comprise substantially no processing additives or other intentionally added material.

FIG. 1C shows an embodiment of the invention wherein a paste (2) for use in and/or for the manufacture of an article (10) used in an electrochemical device, comprises one or more reactive materials (3) and/or reactive composites (4) and a background liquid (8). The reactive composite, when present, may comprise one or more reactive materials (3) and one or more matrix materials (5). The process mixture (9), such as a dry blend (1) or paste (2), may further comprise one or more binders (6). One or more of the reactive materials may comprise one or more active materials (3a) and/or one or more precursor materials (3b). The precursor material (3b) may be a precursor to an active material (3a). The paste (2) may further comprise one or more conductive additives (7). The conductive additives may form a conductive pathway through all or part of the material. In the embodiment of FIG. 1C, the binder (6) may be distributed around the other materials (reactive materials (3, 3a, 3b), reactive composites (4, 4a, 4b), conductive additives (7)). According to one aspect of the invention, this may occur, for instance, before, during or after processing when the binder (6) may become fully or partially fibrillized. In such a circumstance, some or all of said other (non-binder) materials may be in the form of particles and/or grains and/or are in solid phase. The paste (2) may comprise substantially no non-fibrillizable binders.

FIG. 1D shows an embodiment of the invention wherein, in the paste (2) some or all of the reactive materials (3, 3a, 3b) and/or some or all of the reactive composites (4, 4a, 4b) and/or some or all of the matrix materials (5) and/or some or all of the binders (6) and/or some or all of the conductive additives (7) and/or any combination thereof are in the form of particles and/or grains and/or are in solid phase. According to one aspect of the invention, this may occur, for instance, before, during or after processing when the binder (6) has not or has not yet become fully or partially fibrillized.

The paste (2) may have the same composition as the dry blend except for the addition of one or more background fluids (8). The paste (2) may comprise less than 85% liquid and/or background fluid (8) by mass. A dry blend (1) may be derived from a paste (2). A dry blend (1) may comprise substantially no processing additives or other intentionally added material.

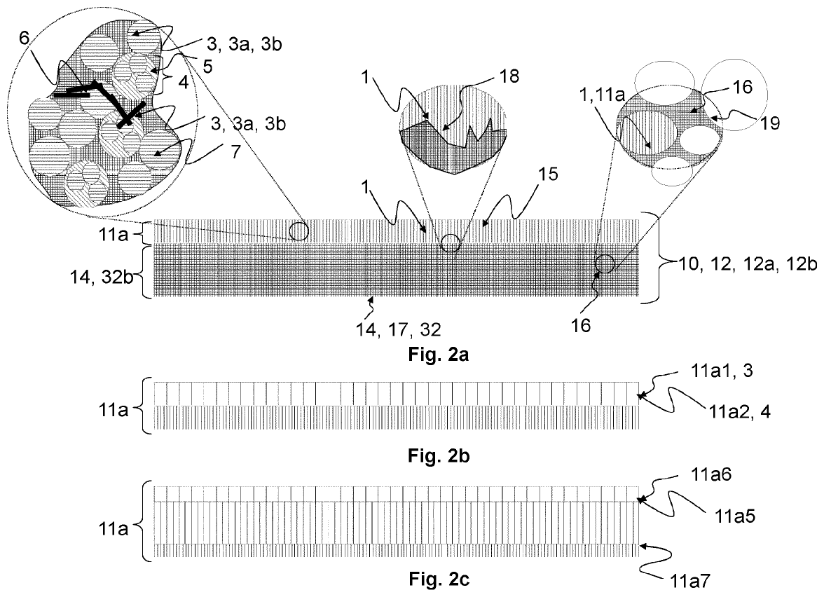

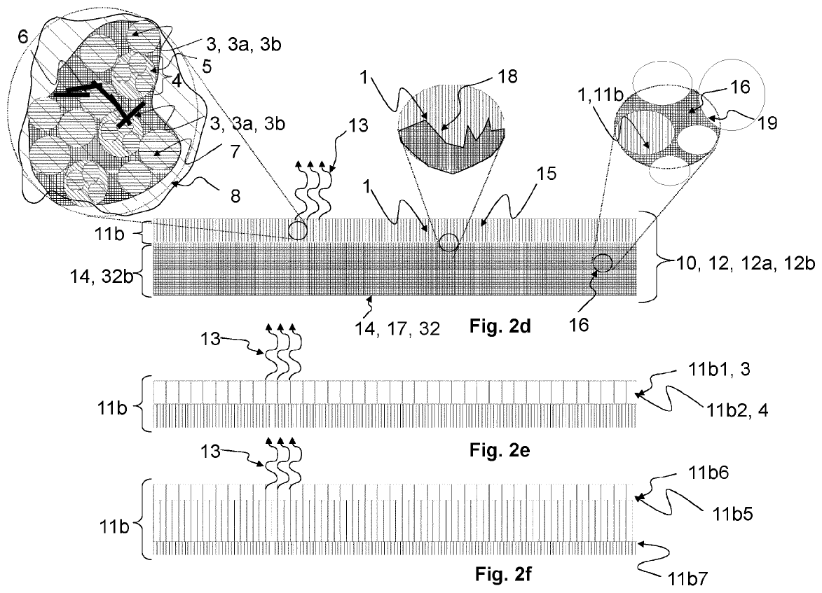

FIG. 2a shows an embodiment an article (10) of the invention for use in an electrochemical device (40). The article (10) may comprise a dry film (11a), alone or in combination with one or more additional elements. The dry film (11a) may comprise a dry blend (1) of the invention and/or be derived from the process mixture (9), such as the dry blend (1) and/or paste (2), of the invention. The dry film (11a) may comprise one or more reactive materials (3) and/or reactive composites (4). The reactive composite, when present, may comprise one or more reactive materials (3) and one or more matrix materials (5). The dry film (11a) may further comprise one or more binders (6). The dry film (11a) may further comprise one or more conductive additives (6). The dry film (11a) may be continuous. The dry film (11a) may be self-supporting or a freestanding film (11c). The dry film (11a) may be adhesive. Some or all of the one or more conductive additives (7) may make direct ohmic contact within the dry film so as to form one or more conductive pathways within the dry film (11a). The dry film (11a) may be an element of an electrode (12), i.e., an anode (12a) and/or a cathode (12b). The electrode may be part of an electrochemical device (40). The dry film (11a) may be bonded to, adhered to or otherwise coupled with a final substrate (32b). The final substrate (32b), such as an adhesive substrate (14), which may be a solid or perforated sheet, foam, network, sintered powder or agglomerate or mesh of material, may be electrically conductive and/or may have an adhesion enhancing surface (15) and/or morphology (16). The adhesion enhancing surface may comprise a chemical or physical adhesion promoter and/or may have a rough and/or porous and/or textured surface (18). The adhesion enhancing morphology may contain voids and/or channels (19). Some or all of these voids and/or channels (19) may become fully or partially filled with dry film (11a) material and/or dry blend (1), some of which may be directly connected to the bulk dry film (11a). The final substrate (32b) may be a current collector (17) which may be an anodic current collector (17a) or cathodic current collector (17b). The dry film (11a) bonded to, adhered to or otherwise coupled with the current collector (17), may be an electrode (12), e g , and anode (12a) and/or a cathode (12b). Said anode (12a) and/or cathode (12b) may be used in an electrochemical device (40).

FIG. 2b shows an embodiment of the invention in which some or all of the reactive material (3) and/or reactive composite (4), matrix material (5) and binder (6) may be intermixed within the dry film (11a) with a first ratio (11a1), wherein some of the reactive material (3) and/or reactive composite (4), matrix material (5) and binder (6) may be intermixed within the dry film 10 with at least one opposing different second ratio (11a2), wherein the first ratio of materials provides enhanced electrode functionality, and wherein the second ratio of materials provides enhanced adhesive functionality.

FIG. 2b also shows an embodiment of the invention in which some or all of the conductive additive (7) may be intermixed within the dry film (11a) with a first ratio (11a3), wherein some of the conductive additive (7) may be intermixed within the dry film (11a) with at least one opposing different second ratio (11a4), wherein the second ratio provides higher conductivity than the first ratio.

FIG. 2c shows an embodiment of the invention in which the ratio of reactive material (3) and/or reactive composite (4) and/or matrix material (5) and/or binder (6) and/or the conductive additive (7) may be distributed within the dry film (11a) with a gradually changing gradient (11a5) between the starting composition (11a6) and the ending composition (11a7) of one or more of the reactive materials (5) and/or reactive composites (4) and/or matrix materials (5) and/or binders (6) and/or conductive additive (7).

FIGS. 2d-2f show various embodiments of the invention wherein the pasty film (11b) may be deposited on the final substrate (32b), such as an adhesive substrate (14), which may be a solid or perforated sheet, foam, network, sintered powder or agglomerate or mesh of material, may be electrically conductive and/or may have an adhesion enhancing surface (15) and/or morphology (16). Subsequently or simultaneously, the background fluid (8) may be removed (13) to create a dry film (11a) which may be adhered to the final substrate (32b).

FIG. 2d shows an intermediate step in producing an article (10) of the invention for use in an electrochemical device (40). Said article is here termed a pre-article (101). The pre-article (101) may comprise a pasty film (11b), alone or in combination with one or more additional elements. The pasty film (11b) may comprise a paste (2) of the invention. The pasty film (11b) may comprise one or more reactive materials (3) and/or reactive composites (4). The reactive composite, when present, may comprise one or more reactive materials (3) and one or more matrix materials (5). pasty film (11b) may further comprise one or more binders (6). The pasty film (11b) may further comprises one or more conductive additives (6). The pasty film (11b) may further comprise one or more background fluids (8). The pasty film (11b) may be continuous. The pasty film (11b) may be self-supporting or a freestanding film (11c) The pasty film (11b) may be adhesive. Some or all of the one or more conductive additives (7) may make direct ohmic contact within the dry film so as to form one or more conductive pathways within the pasty film (11b). The pasty film (11b), when the background fluid (8) may be removed (13) may be an element of an electrode (12), such as an anode (12a) and/or a cathode (12b). The anode (12a) and/or cathode (12b) may be part of an electrochemical device (40). The pasty film (11b) may be bonded to, adhered to or otherwise coupled with a final substrate (32b), which may an adhesive substrate (14), such as a solid or perforated sheet, foam, network, sintered powder or agglomerate or mesh of material, may be electrically conductive and/or may have an adhesion enhancing surface (15) and/or morphology (16). The adhesion enhancing surface may comprise a chemical or physical adhesion promoter and/or may have a rough and/or porous and/or textured surface (18). The adhesion enhancing morphology of the final substrate (32b) may contain voids and/or channels (19). Some or all of these may become fully or partially filled with pasty film (11b) material and/or paste (2), some of which may be directly connected to the bulk pasty film (11b). The final substrate (32b) may be a current collector (17), such as an anodic current collector (17a) or cathodic current collector (17b). Once the background fluid (8) is removes (13), the resulting dry film (11a) bonded to, adhered to or otherwise coupled with the collector (17) may be an anode (12a) or a cathode (12b). Said anode (12a) and/or cathode (12b) may be used in an electrochemical device (40).

FIG. 2e shows an embodiment of the invention in an intermediate state according to one embodiment of the invention in which some or all of the reactive material (3) and/or reactive composite (4), matrix material (5) and binder (6) may be intermixed within the pasty film (11b) with a first ratio (11b1), wherein some of the reactive material (3) and/or reactive composite (4), matrix material (5) and binder (6) may be intermixed within the pasty film (11b) with at least one opposing different second ratio (11b2), wherein the first ratio of materials provides enhanced electrode functionality, and wherein the second ratio of materials provides enhanced adhesive functionality.

FIG. 2e also shows an embodiment of the invention in an intermediate state according to one embodiment of the invention in which some or all of the conductive additive (7) may be intermixed within the pasty film (11b) with a first ratio (11b3), wherein some of the conductive additive (7) may be intermixed within the pasty film (11b) with at least one opposing different second ratio (11b4), wherein the second ratio provides higher conductivity than the first ratio.

FIG. 2f shows an embodiment of the invention in an intermediate state according to one embodiment of the invention in which the ratio of reactive material (3) and/or reactive composite (4) and/or matrix material (5) and/or binder (6) and/or the conductive additive (7) may be distributed within the pasty film (11b) with a gradually changing gradient (11b5) between the starting composition (11b6) and the ending composition (11b7) of one or more of the reactive materials (3) and/or reactive composites (4) and/or matrix materials (5) and/or binders (6) and/or conductive additive (7).

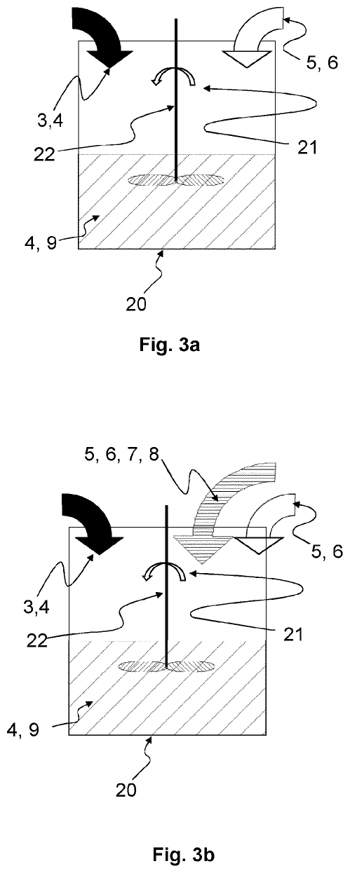

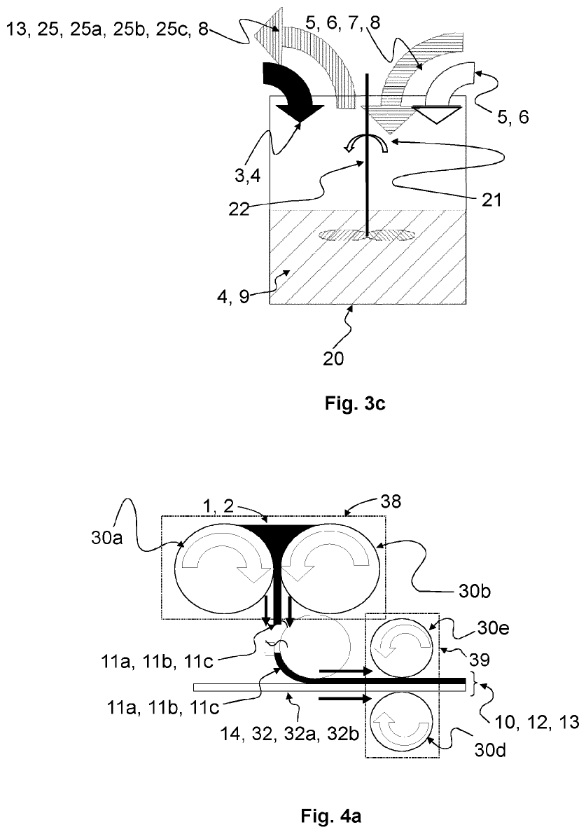

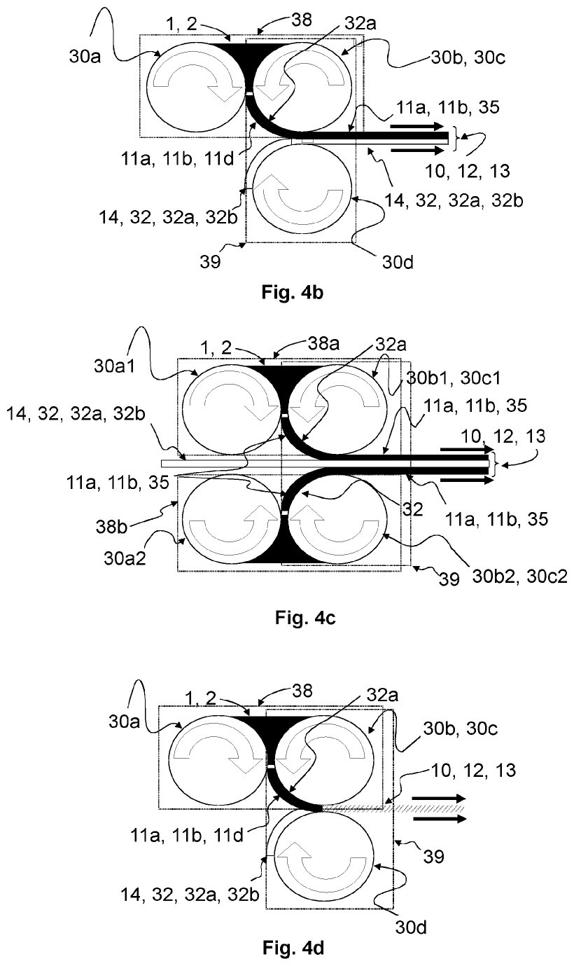

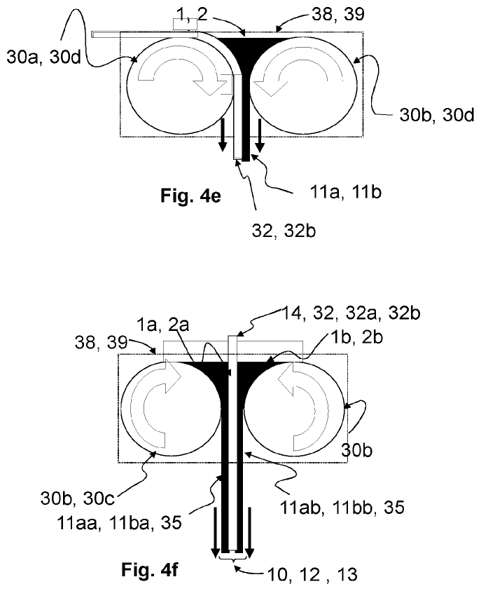

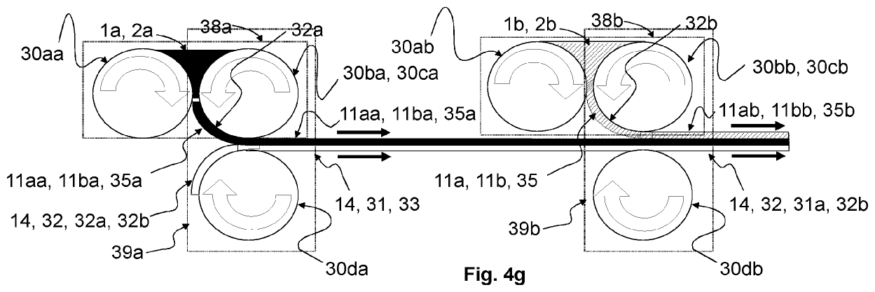

FIGS. 3 and 4 show several embodiments of the method for producing a dry film (11) or an article (10) according to the invention. The described embodiments of the method for making a dry film (11) or an article (10) for an electrochemical device (40), comprise, at least, the steps of:
i. mixing at least one or more reactive materials (3) and/or reactive composites (4) and one or more binders (6) to form a process mixture (9), such as a dry blend (1) or paste (2); and
ii. forming (23) the process mixture (9) to produce one or more films (11), such as one or more dry films (11a) and/or one or more pasty films (11b).

Details of certain embodiments of step i) are shown in FIG. 3. Details of certain embodiments of step ii) are shown in FIG. 4.

FIG. 3a shows one embodiment of the method in which one or more reactive materials (3) and/or reactive composites (4) and one or more binders (6) are mixed (21) in a mixing vessel (20) with a mixer (22) to form a process mixture (9) or one or more reactive materials (3) and one or more matrix material (5) are mixed (21) in a mixing vessel (20) with a mixer (22) to form a reactive composite (4). Any means of mixing (22) are possible according to the invention. During the mixing (31) some or all of any fibrillizable binder (6) may fully or partially fibrillize due to, for instance, the shearing (41), where shear forces generated in the mixing process, depending on the operation of the mixer (22), the type of mixing (21) (e.g., shaking, milling, grinding, shearing, sonicating, shaking, vibrating, mortaring, tumbling, fluidizing and/or stirring), and/or the duration, speed and temperature of the mixing (21). Depending on the liquid content of the mixture, the mixture may be, for instance, a dry blend (1) or a paste (2). In some embodiments, one or more of the reactive materials (3), reactive composites (4), matrix materials (5) and/or binders (6) may be added dry, as a paste or as a dispersion (27), e.g., as a solution (27b), a suspension (27a) or a colloid (27c). In some embodiments, one or more of the reactive materials (3), reactive composites (4), matrix materials (5) and/or binders (6) may be added as dry reactive materials (3), dry reactive composites (4), dry matrix materials (5) and/or dry binders (6). Said dry materials may be in the form of particles and/or grains and/or as one or more powders. In some embodiments one or more of the reactive materials (3), reactive composites (4), matrix materials (5) and/or binders (6) may be added as particles and/or grains of materials. In some embodiments one or more of the reactive materials (3), reactive composites (4), matrix materials (5) and/or binders (6) may be added as dry and/or wet particles and/or grains of materials and/or as a dispersion (27) or paste (2). In some embodiments one or more of the reactive materials (3), reactive composites (4), matrix materials (5) and/or binders (6) may be added as one or more powders. Any combination of the above is possible according to the invention.

FIG. 3b shows an embodiment of the invention wherein a conductive additive (7) and/or a matrix material (5) and/or a background fluid (8) is additionally mixed (21) into the process mixture (9) or wherein a conductive additive (7) and/or a binder (6) and/or a background fluid (8) is additionally mixed (21) into the reactive composite (4). According to one aspect of the invention, any or all of the conductive additive (7), binder (6) and/or a matrix material (5) may be dry, in a paste or in a dispersion (27), e.g. a solution (27b), a suspension (27a) or a colloid (27c) or may be as a dry material. Said dry materials may be in the form of particles and/or grains or as one or more powders. In some embodiments one or more of the conductive additive (7), binder (6) and/or matrix material (5) may be added as dry and/or wet particles and/or grains of materials and/or as a dispersion (27) or paste (2).

FIG. 3c shows an embodiment of the invention wherein a dispersant (25) (be it an solvent (22b), suspendant (22a) and/or colloidant (22c)) and/or a background fluid (8) from one or more of a dispersion (27) and/or paste (2) of one or more of the reactive materials (3), reactive composites (4), binders (6), conductive additive (7) and/or a matrix material (5) is fully or partially removed (13) so as to form a paste (2) or dry blend (1).

One or more of the reactive materials (3) may be an active material (3a) or a precursor material (3b). One or more of the reactive composites (4) may be active composites (4a) or a precursor composites (4b). The active composites and/or precursor composites may be produced by mixing (31) one or more matrix materials (5) with one or more active materials (3a) and/or precursor materials (3b). The mixing may be done by mixing of dry or dispersed active material (3a) and/or precursor material (3b) and matrix material (5). In the case where one or more of said materials are dispersed, the dispersion (27) may be, for instance, a solution (27b), a suspension (27a) or a colloid (27c). In the case where one or more of said materials are dry, one or more of said materials may be in the form of a powder. In the case of a powder, suspension or colloid, any or all of said materials may be in the form of particles and/or grains.

Examples of reactive materials (3) include, but are not limited to NaCl, NaF, Na₂SO₃, Na₂SiO₃, Na₄P₂O₇, NaAlCl₄, NaAlCl₄*xSO₂ (e.g. NaAlCl₄*1.5SO₂ and/or NaAlCl₄*3SO₂), SO₂Cl₂, SO₂, Cl₂, Ni, Cu, CuO, NiO, Cu₂O, Fe, FeO, Fe₂O₃, Fe₃O₄, steel, NiF₂, NiCl₂, FeCl₂, FeCl₃, FeF₂, FeF₃, CuCl₂, CuCl, CuF₂, CuF, Cu(OH)₂, Fe(OH)₂, Cu₂CO₃(OH)₂, Cu(HCOO)₂, Lithium mixed oxides and Lithium mixed phosphates, such as lithium iron phosphate (LFP), Lithium Manganese Iron Phosphate (LMFP), Lithium Nickel Cobalt Manganese oxide (NCM), Lithium Nickel Cobalt Aluminium oxides (NCA), Lithium Manganese oxide (LMO), Lithium Cobalt oxide (LCO) and combinations thereof or any combination thereof. Examples of active materials (3a) include, but are not limited to NaCl, NaF, Na₂SO₃, Na₂SiO₃, Na₄P₂O₇, NaAlCl₄, NaAlCl₄*xSO₂ (e.g. NaAlCl₄*1.5SO₂ and/or NaAlCl₄*3SO₂), SO₂Cl₂, SO₂, Cl₂, Ni, Cu, CuO, NiO, Cu₂O, Fe, FeO, Fe₂O₃, Fe₃O₄, steel, NiF₂, NiCl₂, FeCl₂, FeCl₃, FeF₂, FeF₃, CuCl₂, CuCl, CuF₂, CuF, Lithium mixed oxides and Lithium mixed phosphates, such as lithium iron phosphate (LFP), Lithium Manganese Iron Phosphate (LMFP), Lithium Nickel Cobalt Manganese oxide (NCM), Lithium Nickel Cobalt Aluminium oxides (NCA), Lithium Manganese oxide (LMO), Lithium Cobalt oxide (LCO) and combinations thereof or any combination thereof.

Examples of precursor materials (3b) include, but are not limited to Na₂SO₃, Na₂SiO₃, Na₄P₂O₇, Ni, Cu, Fe, porous carbon, Cu(OH)₂, Fe(OH)₂, Cu₂CO₃(OH)₂, Cu(HCOO)₂ or any combination thereof.

Examples of matrix materials (5) include, but are not limited to ketjen black, graphite, hard carbon, nanotubes, nanofibers, carbon nanotubes, carbon nanofibers, activated carbon, reduced graphene oxide, celite, humic acid, diatomaceous earth, Ni, Cu, Fe, steel, brass, clays, bentonite, caolinite, Ni foam, Cu foam, Al foam, steel wool, Ni-plated metal, Fe-plated metal, microfibers, glass fiber, quartz fibers, basalt fibers, polyamide fibers, polyethylene fibers, polypropylene fibers or any combination thereof.

Examples of binders (6) include but are not limited to theiinoplastics, including but not limited to polyethylene (PE), polypropylene (PP), such as nylon, PLA (Polylactic acid or polylactide), polybenzimidazole (PBI, short for Poly-[2,2′-(m-phenylen)-5,5′-bisbenzimidazole]), polycarbonate, polyether sulfone, polyetherether ketone, polyetherimide, polyethylene oxide (PEO), polyphenylene oxide, polyphenylene sulfide, polypropylene, polystyrene, polyvinyl chloride, acrylic polymers and their derivatives and fluoropolymers and any combination thereof. Examples of acrylic polymers and their derivative binders include, but are not limited to, Acrylic (poly(methyl methacrylate) or PMMA), ABS (acrylonitrile butadiene styrene), methacrylates, methyl acrylates, ethyl acrylates, 2-Chloroethyl vinyl ether, 2-Ethylhexyl acrylates, Hydroxyethyl methacrylates, butyl acrylates and butyl methacrylates and any combination thereof. Examples of fluoropolymer binders include, but are not limited to, polytetrafluoroethylenes (PTFEs), such as Teflon, polyvinylidene fluoride (PVDF), polyvinylidene fluoride-co-hexafluoropropylene (PVDF-HFP) and polyvinylidene fluoride co-polymers, polyvinylfluoride (PVF), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), Perfluorinated Elastomer (FFPM/FFKM), Chlorotrifluoroethylenevinylidene fluoride FPM/FKM, Tetrafluoroethylene-Propylene (FEPM), Perfluoropolyether (PFPE) and Perfluorosulfonic acid (PFSA) and/or any combination thereof.

Examples of conductive additives (7) include but are not limited to conductive materials, e.g. metals, such as Ni, Cu, Fe, Al, brass, steel, CuNi alloys, Ag or metal like materials, such as carbon nanomaterials, e.g. graphene, graphite, nanotubes, fullerenes, carbon nanobuds, glassy carbon and/or carbon nanofoam, carbon nanowires, reduced graphene oxide and/or any combination thereof.

Examples of solvents include but are not limited to water, ethanol, isopropanol, methanol, acetone, N-methyl-2-pyrrolidone, methyl isobutyl ketone, pentane, hexane, heptane, petroleum ether, alkanes, toluene, xylene, SO₂, NaAlCl₄*xSO₂ (e.g. NaAlCl₄*1.5SO₂ and/or NaAlCl₄*3SO₂), benzene or any combination thereof.

Examples of suspendants include but are not limited to water, ethanol, isopropanol, methanol, acetone, N-methyl-2-pyrrolidone, methyl isobutyl ketone, pentane, hexane, heptane, petroleum ether, alkanes, toluene, xylene, NaAlCl₄*xSO₂ (e.g. NaAlCl₄*1.5SO₂ and/or NaAlCl₄*3SO₂), benzene or any combination thereof.

Examples of colloidants include but are not limited to water, ethanol, isopropanol, methanol, acetone, N-methyl-2-pyrrolidone, methyl isobutyl ketone, pentane, hexane, heptane, petroleum ether, alkanes, toluene, xylene, SO₂, NaAlCl₄*xSO₂ (e.g. NaAlCl₄*1.5SO₂ and/or NaAlCl₄*3SO₂), benzene or any combination thereof.

“x” in NaAlCl₄*xSO₂ in any of the examples may be any number between 1 and 5.

One or more of the binders (6) may be fully or partially fibrillizable. Essentially all of the one or more binders (6) may be fibrillizable. Some or all of the binder (6) may be fibrilized during the processing.

The mixing (31) of the one or more matrix materials (5) with the one or more active materials (3a) and/or precursor materials (3b) and/or conductive additives (7) and/or background fluids (8) may be carried out, by any means known in the art. For instance, the mixing (31) may be carried out by dispersing (26) one or more of the matrix materials (5) and one or more active materials (3a) and/or precursor materials (3b) and/or one or more binders (6) and/or conductive additives (7) in one or more dispersants (25) to create a dispersion (27). Essentially all of the one or more of the dispersants (25) and/or some or essentially all of the dispersants (25) may then be essentially fully removed (13) to create a powder. Alternately, only part of the dispersant (25) may be removed (13) to create a paste (2), wherein the dispersant (25) may act as a background fluid (8). Alternately, the mixing (31) may be carried out substantially in the absence of any dispersant (25) to create a mixed powder (35). Alternatively, the mixing may be carried out by any of proceeding methods, further comprising the step of adding a background fluid (8) to create or optimize a paste (2). Some or all of the mixing (31) may be carried out by, for instance shaking, milling, grinding, shearing, sonicating, shaking, vibrating, mortaring, tumbling, fluidizing and/or stirring or by any other means known in the art. The dispersant (25) may be a solvent (25a), a suspendant (25b), and/or a colloidant (25c). The dispersion (27) may be a solution (27b), a suspension (27a) and/or a colloid (27c). The dispersing (26) may comprise suspending (26a), dissolving (26b) and/or colloiding (26c).

Some or all of the reactive materials (3), some or all of the reactive composites (4), some or all of the matrix materials (5), some or all of the binders (6), some or all of the conductive additives (7) and/or some of all of the process mixture (9), such as the dry blend (1) or paste (2), are in the form of particles and/or grains before and/or during and/or after the mechanical forming (23) of the process mixture (9) (e.g. the dry blend (1) or paste (2)) and/or the film (11) (e.g. the dry film (11a) and or pasty film (11b)).

One or more of the dispersants (25) may be removed (13) by, for instance, but not limited to, evaporation, drum drying, filtration, chemical reaction, precipitation, crystallization, extraction, compression, acceleration, deceleration, centrifugation, impaction and/or solidification. Evaporation may be carried out by, for instance, but not limited to, vibration, sonification, heating, vacuuming, spray drying, freeze drying, fluidized bed drying, supercritical drying and/or depressurization. Heating may be, for instance, but not limited to, convective, conductive, vibrational, frictional and/or radiative heating.

As shown in the example method and apparatus embodiments of FIGS. 4a-4g, the method may further comprise producing a film (11), such as a dry film (11a) and/or a pasty film (11b), from the process mixture (9), such as the dry blend (1) and/or paste (2). The process mixture (9) may be produced by any means, which may form a film (11). The process mixture (9), film (11) (e.g. the dry film (11a) and/or pasty film (11b)) may be applying the film (11) to a substrate (32), such as a temporary substrate (32a) and/or a final substrate (32b), such as a an adhesive substrate (14), such as a solid or perforated sheet, foam, network, sintered powder or agglomerate or mesh of material.

In general, the apparatus for manufacture of the article (10), such as the film (11) may comprise one or more film formers (38) and one or more material feeders (45) to feed one or more process mixtures (9) into film former (38). In the embodiments shown in FIGS. 4a-4g, the film former (38) is a calender, though other film formers, such as extruders (not shown), are possible according to the invention. Regarding material feeders (45), in the embodiments shown in FIGS. 4a-4g, the process mixture (9) is simply placed at the top of the calender and the calender cylinder motion feeds the process mixture (9) into the film former (38). Other feeding mechanisms known in the art are possible according to the invention, including, but not limited to, screw, vibratory, rotary, belt, apron, reciprocating, variable rate feeders.

In general, the apparatus for manufacture of the article (10), such as the film (11) on a substrate (32) may comprise one or more film appliers (39), one or more film feeders (45) to feed one or more films (11) into film applier (39). In the embodiments shown in FIGS. 4a-4g, the film applier (39) is a calender, though other film appliers (39), such as compression plates (not shown), are possible according to the invention. Regarding film feeders (45), in the embodiments shown in FIGS. 4a-4g, the film (9) is fed by the film former. Other feeding mechanisms known in the art are possible according to the invention, including, but not limited to roller-2-roll and sheet feeders (not shown). Similarly, the substrate may be fed by any feeding system known in the art, including but not limited to roller-2-roll and sheet feeders (not shown). The film forming (42) calenders may be of different sizes and/or may be rotated at different speeds so as to provide a controlled shear force in the process mixture (9) and/or the film (11). One or more of the film forming (42) calenders may be heated and/or cooled. The surface of one or more of the calendering cylinders may be treated to improve or reduce adhesion.

Shown in FIG. 4a is an embodiment of a method and an apparatus of the invention in which a film (11), such as a dry film (11a) and/or pasty film (11b), is produced by calendering through a gap formed by a first film forming (42) calendering cylinder (30a) and a second film forming (42) calendering cylinder (30b). As an example of an alternative, an extruder (not shown) may be used to form the dry film (11a) or pasty film (11b). Film forming (42) calender cylinder (30a) and film forming (42) calender cylinder (30b) may be of the same or different diameter and/or rotate at the same or different rotation rates such that the most proximate surfaces may have the same or different speeds. Thusly, a shear force may be controlled in the process mixture (9) (e.g. the dry blend (1) and/or paste (2)) as it passes through the nip of the calender. The larger difference in speeds, the larger the shear force generated. The shear forces generated in the mixer (21), shearer (41) and/or film applier (39) may promote the fibrillization of fibrillizable binders present in the process mixture (9). The resulting film (11) may be a self-supporting or a freestanding film (11c) and/or a supported film (11d), which may be supported, for instance, by a substrate (32). A substrate may be a temporary substrate (32a) or a final substrate (32b). A substrate may be rigid or flexible. A final substrate (32b) may be, for instance, an adhesive substrate (14). A temporary substrate (32a), may be, for instance, a portion of a first (30a) and/or a second film forming (42) calendering cylinder (30b). In the examples shown in the various embodiments of FIG. 4, the film forming (42) calendering cylinder (30b) which simultaneously acts as a temporary substrates (32a) is the second film forming (42) calendering cylinder (30b), however film forming (42) calendering cylinder (30a) may also serve as a temporary substrate (32a). A temporary substrate (32a) may also take the form of a, for instance, a release liner (not shown), which may be used to, for instance, store, process before transferring or otherwise apply the dry film (11a) or pasty film (11b) to a final substrate (32b), such as an adhesive substrate (14). A temporary substrate (32a) may be used, for instance, for transferring a film (11), which may be, for instance, a freestanding film (11c), or otherwise not yet deposited and/or adhered to a final substrate (32b). Other forms and implementations of temporary substrates (32a) and final substrates (32b) are possible according to the invention. In the corresponding apparatus for manufacture of the article (10) the film former (38) may comprise one or more calenders comprising at least two calendering cylinders (30a and 30b) in aligned opposition to each other with a pre-defined gap and/or force between the calendering cylinders (30a and 30b); and at least one drive unit turning the calendering cylinders at controlled speed, wherein the feeder (45) is the motion of the calender, which provides the process mixture (9) to the gap between the cylinders so as to compress the process mixture (9) into a film (11).

The film (e.g. the dry film (11a) or pasty film (11b)) is applied to the final substrate (32b) by any means. A preferred means of applying said films is by mechanical compression (37). Additionally, shear forces can be generated by shearing (41) during the application, which may promote the fibrillization of fibrillizable binders present in the dry blend (1), paste (2), dry film (11a) and/or pasty film (11b). FIGS. 4a-4f show various embodiments of the invention, wherein the mechanical compression (37) is carried out by calendering between two or more film application (44) calendering cylinders (30a, 30b, 30c, 30d and 30e). Other means are possible to apply mechanical compression (37), including, but not limited to pressing the dry film (11a) or pasty film (11b) between two or more planar or contoured plates. A shearing force can be added to the mechanical compression (37), by shearing (41) by, for instance, moving the planar and or contoured plates in a planar direction while compressing. Any pair of film forming (42) calender cylinders and/or film application (44) calender cylinders may be of the same or different diameter and/or rotate at the same or different rotation rates such that the most proximate surfaces may have the same or different speeds. Thusly, a shear force may be applied in a controlled manner in the dry blend (1), paste (2), dry film (11a) and/or pasty film (11b) as it passes through the nip of each calender. The larger difference in speeds, the larger the shear force generated during shearing (41).

FIG. 4a shows an embodiment with an optional film applicator (39) is a separate calendering mechanism consisting of film application (44) calendering cylinders (30d and 30e) aligned opposition to each other with a pre-defined gap and/or force between the calendering cylinders and at least one drive unit turning the calendering cylinders at controlled speed, wherein the feeder (45) is the motion of the film forming (42) calender, which provides the film (11) to the 50 gap between the cylinders so as to compress the film (11) into the substrate (32). In this embodiment, one or more freestanding dry films (11a) or pasty films (11b) is fed into the calendering mechanism together with one or more final substrates (32b), which may be an adhesive substrate (14).

FIG. 4b shows an embodiment in which one of the calendering cylinders (30b) is simultaneously part of a film applicator calender (39) and serves as a film application (44) calender cylinder (30c). In this embodiment of the invention, an additional film application (44) calendering cylinder (30d) is added to complete film application (44) calendering mechanism (39). Combined film formation (43) and film application (44) calender cylinder (30b, 30c) also acts as a temporary substrate (32a) for the film (11). In this embodiment of the invention, film application (44) calendering cylinder (30d) also serves as a temporary substrate and substrate feeder (46) for the final substrate (32b), which may be an adhesive substrate (14). Calender (30c) here also acts as part of the substrate feeder (46).

FIG. 4c shows an embodiment similar to the embodiment of FIG. 4b, however, the film former calendering mechanism (39) forces some or all of the dry blend (1), paste (2), dry film (11a) and/or pasty film (11b) into voids and/or channels (19) in the final substrate (32b) such that the dry blend (1), paste (2), dry film (11a) and/or pasty film (11b) is not a distinct layer separate from the final substrate (32b), which may be an adhesive substrate (14).

FIG. 4d shows an embodiment similar to the embodiment of FIG. 4b, however, there are two film former calendering mechanisms (38) and two film appliers (39) calendering mechanisms applying film (11) on two sides of the same substrate. Here calendering cylinders (30a1 and 30b1) form a first film former (38a) and calendering cylinders (30a2 and 30b2) form a second film former (38b). Here also, calendering cylinders (30c1 and 30c2) form a film applier (39). Calendering cylinders (30b1 and 30c1) are one-in-the-same and calendering cylinders (30b2 and 30c2) are one-in-the-same and serve as part of the film former (38) and film applier (39).

FIG. 4e shows an embodiment similar to the embodiment of FIG. 4a, however, an adhesive substrate is fed through the film forming (42) calender (30a) such that film forming (42) calender (3a) also acts as a film application (44) calendering cylinder (30d). Thus, the film former (38) and the film applier (39) are one-in-the-same. In this embodiment, only a single pair of calendering cylinders are needed to both form and apply the dry film (11a) or pasty film (11b).

FIG. 4f shows an embodiment similar to the embodiment of FIG. 4e, however, an adhesive substrate is fed between forming calenders (30a and 30b) such that a first dry blend (1a) or a first paste (2a) is formed in a first dry film (11aa) or first pasty film (11ba) and a second dry blend (1a) or a second paste (2a) is formed in a second dry film (11ab) or a second pasty film (11bb). In this embodiment, only a single pair of calendering cylinders are needed to both form and deposit two dry films (11aa and 11ab) or pasty films (11ba and 11bb). The composition of the first dry blend (1a) or first paste (2a) may be the same or different that the second dry blend (1a) or a second paste (2a).

FIG. 4g shows an embodiment similar to the embodiment of FIG. 4b, however, having a second film former (38) calender cylinder pair (30ab and 30bb) and a second film applier (39) calendering cylinder pair (30cb and 30db) forming and applying a second dry film (11ab) and/or second pasty film (11bb) from a second dry blend (1b) and/or a second paste (2b), each being separate and distinct from the first film forming (42) calender cylinder pair (30aa and 30ba) and a first film application (44) calendering cylinder pair (30ca and 30da) forming and applying a first dry film (11aa) and/or first pasty film (11ba) from a first dry blend (1a) and/or a first paste (2a). The properties (for example, but not limited to grain size, amount of fibrillization, composition, wetness and/or temperature) of the first dry blend (1a) and/or a first paste (2a) may be the same or different from the properties of the second dry blend (1b) and/or a second paste (2b). The properties (for example, but not limited to thickness, grain size, amount of fibrillization, composition, wetness and/or temperature) of the first dry film (11aa) and/or a first pasty film (2aa) may be the same or different from the properties of the second dry blend (11ab) and/or a second pasty film (11bb). By analogy, additional processing steps and equipment (not shown) may be added to produce additional dry blends (1), pastes (2), dry films (11a) and/or pasty films (11b) and apply them on top of previous additions. By this means, a multi-layered dry film (11a) and/or pasty film (11b) may be produced. By varying the properties of each subsequent application, the properties of the dry film (11a) and or pasty film (11b) may be made to vary in the direction perpendicular to the film and/or adhesive substrate. The same or similar procedure can be applied to any of the previous examples to achieve the same or similar effects in the product.

Another method according to the invention to achieve a same or similar effect is to vary the properties of the process mixture (e.g. the dry blend (1) and/or paste (2)) perpendicular to the flow of material between the film forming (42) calender cylinders in any of the embodiments presented.

According to the various embodiments of the invention, a shear force may be applied, e.g. by shearing (41), to all or part of the process mixture (9), such as the dry blend (1) and/or paste (2), and/or the components thereof, at any stage of the article (10) manufacturing process. This may be before and/or during and/or after mechanically compressing (37), shearing (41), mixing (21), and/or application to the substrate. This may be during the mixing of process mixture (9). This may be during film formation (43). This may be during the application of a first or any subsequent application processes. The application of shear force may fibrillizes some or all of the one or more fibrillizable binders.

Some or all of the process mixtures (9), one or more of the films (11), and/or the components thereof may be heated and/or cooled at any time or stage in the process, as may be required to achieve the various process ends. Any mixing vessel (20), calendering cylinder (30), extruder, temporary substrate (32a), final substrate (32b) or adhesive substrate (14) and/or any other process component may be heated or cooled before, during and/or after mechanically compacting, mixing and/or, wherein the film (11) is heated before, during and/or after applying the film (11) to the final substrate (32b).

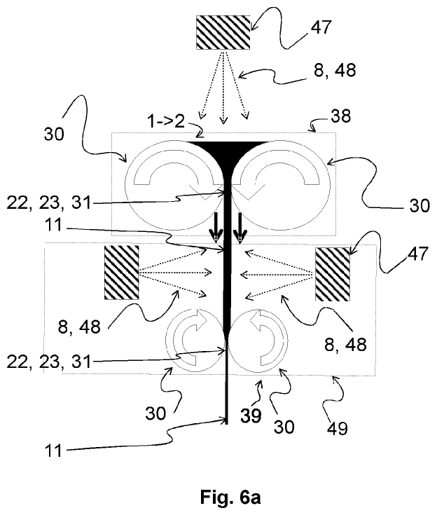

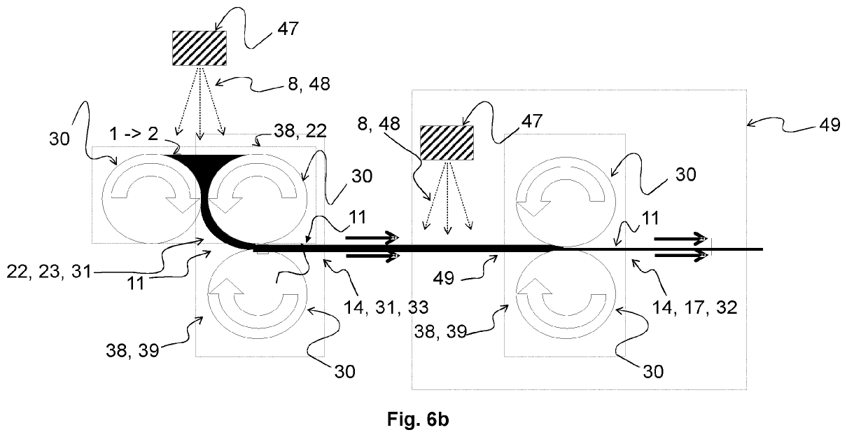

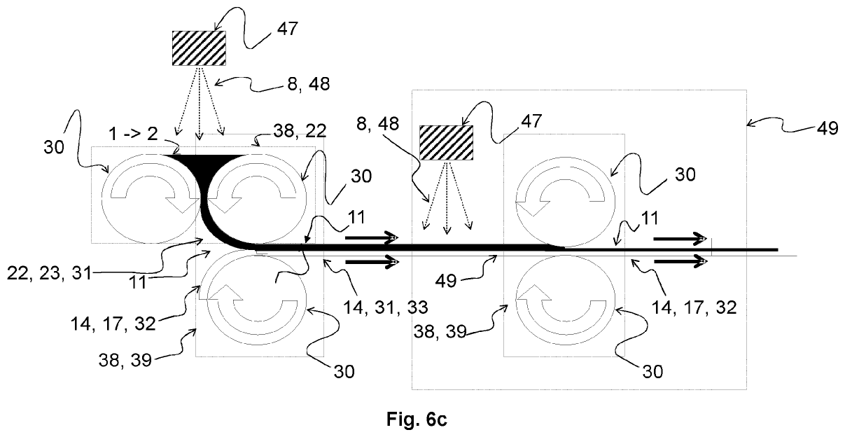

FIG. 6 shows example embodiments of the invention wherein a process mixture (9), such as a dry blend (1) is converted to a paste (2) by wetting (48), e.g. with a wetter (47), such as a sprayer, with one or more processing additives, such as background fluid (8), prior to or during the first film forming in a film former (38). The background fluid (8) may be mixed with a dry blend (1) to form a paste (2) prior to film forming (42) or during film forming (23, 42) in a film former (38), which may also act as a mixer (22) and/or a shearer (41) to mix (31) and/or shear the dry blend (1) and background fluid (8). Some or all of the processing additives, such as background fluid (8), may be removed when the process mixture passes through any of the nips of the process or elsewhere in the process, for instance by evaporation, gravity, or vibration. In one embodiment the film (11) exiting the film former (38) may be a dry film (11a). In some embodiments (FIGS. 6a and 6b) the film exiting the film former (38) may be a pasty film (11b). The film (11) may exit the film former as a freestanding film (11). Additional processing additives, such as background fluid (8), may be added to the freestanding film (11) to with an additional wetter, such as a sprayer (47), to maintain or regenerate a paste (2) or pasty film (11b). The freestanding or supported pasty film (11b) may be fed into another film former (42)/mixer (22)/shearer (41) to further process (e.g. mix and/or make thinner) the film (not shown). This combined wetting and/or forming and/or mixing and/or shearing process (49) may be repeated any number of times (not shown) to control the film thickness and other properties. Alternatively, as shown in FIG. 6c, the film may be applied to a substrate (32), such as an adhesive substrate (14) and/or a current collector (17) in a film applier (39). The film applier (39) may further form the film (42) and act as a mixer (22) and/or shearer (41). The film (11) exiting the film applier (39) may be a dry film (11a) or a pasty film (11b). Additional processing additives, such as background fluid (8), may be added to the freestanding and/or supported film (11) with an additional wetter, such as a sprayer (47), to maintain or regenerate a paste (2) or pasty film (11a). The supported pasty film (11b) may be fed into another film former (42)/mixer (22)/shearer (41) to further process (e.g. mix and/or make thinner) the film. This combined wetting and/or forming and/or mixing and/or shearing process (49) may be repeated any number of times, for instance in series (not shown), to control the film thickness and other film properties.

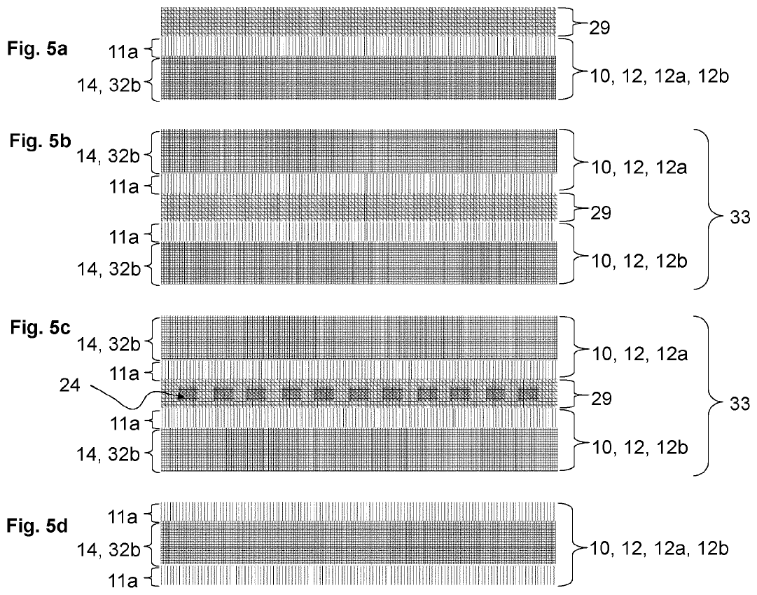

FIG. 5a shows one embodiment of an electrochemical device (40) according to the invention. The electrochemical device (40) may comprise an electrode (12), such as an anode (12a) and/or a cathode (12b) and an electrolyte (29). The anode (12a) and cathode (12b) may comprise a dry film (11a) and a current collector (17), the anodic current collector (17a) as part of the anode (12a) and the cathodic current collector (17b) as part of the cathode (12b). The electrode (12) may comprise elements of the process mixture (9), such as the dry blend (1) or paste (2). The electrode may comprise elements of an article (10), such as a film (11), such as a dry film (11a) or pasty film (11b). The device may comprise an article comprising a dry film (11a). The components of the device may be made my any of the previously presented means or methods.

FIG. 5b shows one embodiment of the electrochemical device (40) in which the device is an electrochemical cell (33). The electrochemical cell (33) may comprise an anode (12a) of the invention, a cathode (12b) of the invention, and an electrolyte (29) between them. FIG. 5c shows the embodiment of FIG. 5b, further comprising a separator (24) between the anode (12a) and cathode (12b). In one embodiment of the invention, the dry blend (1) and/or the dry film (11a) of the article (10) are adhered to or otherwise coupled with to the separator (24). The bonding may be by any means, but dry bonding is preferred. The electrochemical cell (33) may be, for instance, a battery cell, a supercapacitor cell or an electrodeposition cell.

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

### EXAMPLES

### Example 1

160.0 g of dry active material (3a) NaCl and 40.0 g of dry matrix material (5) ketjen black were mixed (21) in a mixer (22) comprising a ball mill with 4 kg of 5 mm stainless steel (SS316) balls in a mixing vessel (20), a 180 mm diameter stainless steel barrel, at 70 RPM for 10 hours to produce a dry active composite (4a). The resulting mixture of dry active composite (4a) in powder form was sifted through a 2 mm stainless steel mesh to remove the largest particles. 19.0 g of resulting dry active composite (4a) powder was manually mixed (21) in a mixing vessel (20) with 1.0 g of Daikin F104 PTFE and mixed (21) and sheared (41) in an electric mortar mixer (22) for 7 minutes at 130 C to fibrillate the binder (6) and form produce flakes of dry blend (1). Resulting film was broken into flakes. The dry flakes were further mixed (21) and sheared (41) using Retch ZM200 homogenizing machine at 8000 RPM using a 12-tooth rotor, and 500 μm sieve. The resulting dry blend (1) powder was fed into the gap between two calendering cylinders (30) of a film former (38) calender machine to produce a dry film (11a), which was also a freestanding film (11c), wherein the rollers were pre-heated up to 100 C, a linear force of 3000N was applied and the velocity of each of the calendering cylinders were 10 mm/sec and 5 mm/sec respectively, with the gap between two calendering cylinders (30) set to 50 μm. Afterwards, the freestanding dry film (11a, 11c) was laminated onto an nickel mesh substrate (14, 32) by feeding the freestanding dry film (11a, 11c) and the aluminum mesh substrate (14, 32) into the gap between two calendering cylinders (30) of a film applier (39) calender machine to produce a cathode (21a), wherein the calendering cylinders were pre-heated up to 100 C, a linear force of 3000N was applied and the velocity of each of the calendering cylinders were 5 mm/sec and 5 mm/sec respectively and the gap was 150 μm. The produced cathode was assembled into an electrochemical cell together with a glass fiber seperator and a nickel anode and NaAlCl₄:1.5SO₂ electrolyte.

### Example 2

47.5 g of dry active material (3a) NaF and 2.5 g of dry matrix material (5) ketjen black were mixed (21) in a mixer (22) comprising a ball mill with 4 kg of 5 mm stainless steel (SS316) balls in mixing vessel (20), a 180 mm diameter stainless steel barrel, at 70 RPM for 10 hours to produce a dry active composite (4a). The resulting powder of dry active composite (4a) in powder form was sifted through a 2 mm stainless steel mesh to remove the largest particles. 19.0 g of resulting dry active composite (4a) powder was manually mixed (21) in a mixing vessel (20) with 1.0 g of Daikin F104 PTFE and mixed (21) and sheared (41) in an electric mortar mixer (22) for 7 minutes at 130 C to fibrillate the binder (6) and form produce flakes of dry blend (1). The dry flakes were further mixed (21) and sheared (41) using Retch ZM200 homogenizing machine at 8000 RPM using a 12-tooth rotor, and 500 μm sieve. The resulting dry blend (1) powder was fed into the gap between two calendering cylinders (30) of a film former (38) calender machine to produce a dry film (11a), which was also a freestanding film (11c), wherein the rollers were pre-heated up to 100 C, a linear force of 3000N was applied and the velocity of each of the calendering cylinders were 10 mm/sec and 5 mm/sec respectively, with the gap between two calendering cylinders (30) set to 50 μm. Afterwards, the freestanding dry film (11a, 11c) was laminated onto an nickel mesh substrate (14, 32) by feeding the freestanding dry film (11a, 11c) and the aluminum mesh substrate (14,32) into the gap between two calendering cylinders (30) of a film applier (39) calender machine to produce a cathode (21a), wherein the calendering cylinders were pre-heated up to 100 C, a linear force of 3000N was applied and the velocity of each of the calendering cylinders were 5 mm/sec and 5 mm/sec respectively and the gap was 150 μm. The produced cathode was assembled into an electrochemical cell together with a glass fiber seperator and a nickel anode and NaAlCl₄:1.5SO₂ electrolyte.

### Example 3

Active material (3a) carbon-coated Lithium Manganese Iron Phosphate (LMFP) and matrix material (5) carbon black were mixed (21) in a mixer (22) in the absence of a dispersant (25) with weight proportions 93.6:6.38 until visually homogeneous to produce a dry active composite (4a). Dry binder (6) PTFE Daikin F₁₀₄ was then added to the mixture and was mixed (21) in a mixer (22) with the resulting mixture in weight proportion 6:94 until visually homogeneous. The resulting powder was then mixed (21) in Mortar mixer (22) with pre-heated mortar and pestle up to 110 C until the powder mixture became plastiline-like. Then, the resulting plastiline mixture was then sheared (41) using ultra centrifugal milling machine. The resulting dry blend (1) powder was fed into the gap between two calendering cylinders (30) of a film former (38) calender machine to produce a dry film (11a), which was also a freestanding film (11c), wherein the rollers were pre-heated up to 100 C, a linear force of 8200N was applied and the velocity of each of the calendering cylinders were 1 mm/sec and 3 mm/sec respectively. Afterwards, the freestanding dry film (11a, 11c) was laminated onto an aluminum mesh substrate (14, 32) by feeding the freestanding dry film (11a, 11c) and the aluminum mesh substrate (14,32) into the gap between two calendering cylinders (30) of a film applier (39) calender machine to produce a cathode (21a), wherein the cylinders (30) were pre-heated up to 100 C, a linear force of 8200N was applied and the velocity of each of the calendering cylinders were 1 mm/sec and 5 mm/sec respectively. The produced cathode was assembled into an electrochemical cell together with a glass fiber seperator and a graphite anode and 1 molar LiDFOB electrolyte.

### Example 4

3.0 g of active material (3) Na₂SO₃ and 3.0 g of matrix material (5) ketjen black were mixed (21) in a mixer (22), ball milled with 4 kg of 5 mm stainless steel (SS316) balls, in a mixing vessel (20), a 180 mm diameter stainless steel barrel at 70 RPM for 10 hours for form a dry active composite (4a). The resulting dry active composite (4a) powder was mixed (21) in a mixer (22) with 1.2 g of binder (6), stabilized 60% PTFE, suspension in dispersant (25), water diluted by 7.5 g of isopropanol and 7.5 g of water, which, in this case was a suspendant (25a). After homogenization the resulting material was further mixed (21) and sheared (41) in an electric mortar for 10 minutes to fibrillize the binder (6) and produce a paste (2). This resulting paste (2) was fed into the gap between two calendering cylinders (30) of a film former (38) calender machine to produce a pasty film (11b), which was also a freestanding film (11c), wherein the cylinders (30) were at room temperature and the velocity of both of the calendering cylinders were 10 mm/sec, with the gap between two calendering cylinders (30) set to 150 μm.

### Example 5

Active material mixture (3) comprising NaCl and matrix material (5) ketjen black were combined in a ball mill with stainless steel (SS316) balls, in a mixing vessel, a 180 mm diameter stainless steel barrel, at 70 RPM for 10 hours to form a dry active composite (4a). PTFE was added to the same barrel and milled for 1 hour more at the same conditions. The resulting material was sprayed with isopropanol to produce a paste having approximately 5% isopropanol by mass and fed into the gap between two calendering cylinders of film former calender machine to produce a thick free-standing film, wherein the cylinders were at room temperature and the velocity of both of the calendering cylinders were 5 mm/s with the gap between two calendering cylinders set to 1000 μm. Most of the isopropanol was removed from the material by calendering. The resulting film thickness then was decreased by subsequently wetting the film by spraying with isopropanol to maintain 5% isopropanol by mass and passing the film between the calender cylinders multiple times with a subsequent decrease of the gap between passes and comparing actual film thickness to target thickness (typical 300 μm) to determine termination of the process.

1. A process mixture (9) for use in and/or for the manufacture of dry film (11a) for an article (10) used in an electrochemical device (40), the process mixture (9) ingredients comprising a predetermined ratio of:
i. one or more reactive materials (3) and/or reactive composites (4), wherein the reactive composite comprises one or more reactive materials (3) and one or more matrix materials (5); and
ii. one or more binders (6),
wherein:
a) the process mixture (9) is a paste (2); or
b) the process mixture (9) is a dry blend (1) or a paste (2) and one or more of the reactive materials (3) comprises a salt comprising a metal containing cation and an anion.

2. The process mixture (9) of claim 1,
i. further comprising one or more conductive additives (7) in a predetermined ratio to the ingredients of claim 1; and/or
ii. wherein one or more of the binders is an element of the process mixture (9) as a whole and/or wherein one or more of the binders is an element of one or more of the reactive composites (4); and/or
iii. wherein one or more of the reactive materials (3) is an active material (3a) and/or a precursor material (3a), wherein the precursor material (3b) is a precursor to an active material (3a) and/or, wherein one or more of the reactive composites (4) is an active composite (4a) or a precursor composite (4b), wherein the precursor material (3b) is a precursor to an active material (3a), and/or
iv. wherein some or all of the reactive materials (3) and/or some or all of the reactive composites (4) and/or some or all of the matrix materials (5) and/or some or all of the binders (6) and/or some or all of the conductive additives (7) and/or any combination thereof in the process mixture (9) and/or one or more of the reactive composites (4) are in the form of particles and/or grains and/or are in solid phase, and/or
v. wherein at least some of the one or more binders (6) is fibrillizable and/or is fibrillized, and/or
vi. wherein the process mixture (9) comprises substantially no non-fibrillizable binders (6).

3. The paste (2) of any of claims 1-2, wherein the paste (2) comprises less than 85% liquid and/or background fluid (8) by mass and/or, wherein the the paste (2) comprises between 85% and 0.1% liquid and/or background fluid (8) by mass.

4. The dry blend (1) of any of claims 1-2 and/or a dry blend (1) derived from the paste (2) of any of claims 1-3, wherein:
i. the dry blend (2) comprises substantially no liquids; and/or,
ii. the dry blend (2) is a dry powder; and/or,
iii. the reactive materials (3) are dry reactive materials (3) and/or the reactive composites (4) are dry reactive composites (4) and/or the matrix materials (5) are dry matrix materials (5) and/or the binders (6) are dry binders (6) and/or the conductive additives (7) are dry conductive additives (7); and/or,
iv. the dry blend (1) is made from a paste (2) of any of claims 1-3.

5. The dry blend (1) of any of claims 1-4, wherein the dry blend (1) comprises substantially no processing additives or other intentionally added material.

6. The process mixture (9) of any of claims 2-5, wherein one or more of the conductive additives (7) comprises carbon or an allotrope thereof and/or a metal and/or conductive additive is in the form of a conductive high aspect ratio particle.

7. The process mixture (9) of any of claims 1-6, wherein one or more of the reactive materials (3) comprises a salt comprising a metal containing cation and an anion and/or, wherein one or more of the matrix materials comprises carbon and/or an allotrope of carbon.

8. The process mixture (9) of claim 7, wherein the metal of the salt's metal containing cation comprises an alkali metal and/or the salt's anion is a halide.

9. An article (10) for use in an electrochemical device (40), comprising:
a dry film (11a), the dry film (11a) comprising the dry blend (1) of any of claims 1 b)-8 and/or derived from the process mixture (9) of any of claims 1-8.

10. The article (10) of claim 9, wherein:
i. the dry film (11a) is a freestanding film (11c), a supported film (11d) and/or is continuous and/or adhesive, and/or
ii. some or all of the one or more conductive additives (7) makes direct ohmic contact within the dry film (11a) so as to form one or more conductive pathways within the dry film (11a), and/or
iii. the dry film (11a) is an element of an anode (12a) or a cathode (12b), and/or
iv. the dry film (11a) is bonded to, adhered to or otherwise coupled with a final substrate (32b).

11. The article (10) of claim 10, wherein the final substrate (32b) is an adhesive substrate (14) and/or is electrically conductive and/or has an adhesion enhancing surface (15) and/or an adhesion enhancing morphology (16).

12. The article (10) of claim 11, wherein:
i. the adhesion enhancing surface (15) is a rough and/or porous and/or textured surface; and/or
ii. the electrically conductive final substrate (32b) is a current collector (17).

13. The article (10) of claim 12, wherein the current collector (17) is an anodic current collector (17a) or a cathodic current collector (17b) and wherein the dry film (11a) bonded to, adhered to or otherwise coupled with the anodic current collector (17a) or the cathodic current collector (17b) is an anode (12a) or a cathode (12b).

14. The article (10) of any of claims 9-13, wherein:
i. some or all of the reactive material (3) and/or reactive composite, matrix material (5) and binder (6) is intermixed within the dry film (11a) with a first ratio (11a1), wherein some of the reactive material (3) and/or reactive composite (4), matrix material (5) and binder (6) is intermixed within the dry film (11a) with at least one opposing different second ratio (11a2), wherein the the dry film (11a) with first ratio of materials provides enhanced electrode functionality, and wherein the dry film (11a) with the second ratio of materials provides enhanced adhesive functionality; and/or,
ii. some or all of the conductive additive (7) is intermixed within the dry film (11a) with a first ratio (11a3), wherein some of the conductive additive (7) is intermixed within the dry film (11a) with at least one opposing different second ratio (11a4), wherein the dry film (11a) with the second ratio (11a4) provides higher conductivity than the dry film (11a) with the first ratio (11a3); and/or
iii. the ratio of reactive material (3) and/or reactive composite (4) and/or matrix material (5) and/or binder (6) and/or the conductive additive (7) is distributed within the dry film (11a) with a gradually changing gradient (11a5) of one or more of the reactive materials (5) and/or reactive composites (4) and/or matrix materials (5) and/or binders (6) and/or conductive additive (7).

15. A method for making a dry film (11a) or an article (10) for an electrochemical device, comprising the steps of:
i. preparing the process mixture (9) of any of claims 1-8 by mixing the predetermined ratio of ingredients in a mixer (22); and
ii. forming (23) the process mixture (9) into the film (11) of the article (10) of any of any of claims 9-14 in a film former (38), wherein the film (11) is a dry film (11a) or pasty film (11b).

16. The method of claim 15, wherein one or more of the reactive composites (4b), are produced by separately mixing (31) one or more matrix materials (5) and one or more reactive materials (3) in a mixer (22) to form a dry reactive composite and/or, wherein one or more of the reactive composites (4b), are produced by separately mixing (31) one or more matrix materials (5), one or more reactive materials (3) and one or more background fluids (8) and/or dispersants (25) in a mixer (22) or under a wetter to form a wet reactive composite.

17. The method of any of claims 15-16, wherein some or all of the mixing (31) is carried out:
i. by shaking, milling, grinding, shearing, sonicating, shaking, vibrating, mortaring, tumbling, fluidizing and/or stirring; and/or
ii. by dispersing (26) one or more of the matrix materials (5) and one or more reactive materials (3) and/or one or more binders (6) and/or conductive additives (7) in one or more dispersants (25) to create a dispersion (27) and then fully removing the dispersant (25) to create a mixed powder (35) or partially removing the dispersant (25) to create a paste (2), wherein the remaining dispersant (25) acts as a background fluid (8); or
iii. substantially in the absence of any dispersant (25) to create a mixed powder (35); or
iv. by any of methods 17 i), 17 ii and/or 17 iii), further comprising the step of adding a background fluid (8) to create a paste (2).

18. The method of claim 17, wherein:
i. the dispersant (25) is a solvent (25a), a suspendant (25b), and/or a colloidant (25c) and/or the dispersion (27) is a solution (27ba), a suspension (27a) and/or a colloid (27c) and/or dispersing (26) comprises suspending (26a), dissolving (26b) and/or colloiding (26c); and/or
ii. some or all of the dispersant (25) is removed (13) by evaporation, drum drying, filtration, chemical reaction, precipitation, crystallization, extraction, compression, acceleration, deceleration, centrifugation, impaction and/or solidification; and/or
iii. the process mixture (3) is sheared (41) during the mixing (31).

19. The method of any of claims 15-18, further comprising the step of applying (28) the film (11) to a final substrate (32b).

20. The method of claim 19, wherein the film (11) is applied to the final substrate (32b) by mechanical compression (37) and/or wherein the film (11) is sheared (41) during film forming (42) and/or film application (44) and/or, wherein the final substrate is an adhesive substrate (14).

21. The method of claim 20, wherein the mechanical compression (37) and/or the shearing (41) is carried out by calendering between two or more calendering cylinders (30) having the same or different surface speeds at the nip between the calendering cylinders (30) and/or pressing between two or more stationary, co-moving or non-co-moving planar or contoured plates, and/or, wherein some or all of the process mixture (9), the film (11) and/or any of the components thereof are heated and/or cooled before, during and/or after after applying the film (11) to the final substrate (32b).

22. The method of any of claims 15-22, wherein the shearing (41) during mixing (31), film formation (43) and or film application (44) fully or partially fibrillizes some or all of the one or more fibrillizable binders (6).

23. An electrochemical device (40) comprising the process mixture (9) of any of claims 1-8, the article (10) of any of claims 1-14, and/or an article (10) made according to the method of any of claims 15-23.

24. The electrochemical device (40) of claims 23, wherein the electrochemical device (40) is an electrochemical cell (33) comprising an electrolyte and an anode (12a) and/or a cathode (12b), wherein the anode (12a) comprises an article (10) and/or cathode (12b) comprise an article (10).

25. The electrochemical device (33) of claim 24, further comprising a separator (24) and/or, wherein the cell is a battery cell, a supercapacitor cell or an electrodeposition cell.

26. The electrochemical device (40) of claim 25, wherein the dry blend (1) and/or the dry film (11a) of one or more of the one or more articles (10) are bonded to, adhered to or otherwise coupled with the separator (24).
